(19) United States
(12) Patent Application Publication
(10) Pub. No.: US 2005/0064328 A1
(43) Pub. Date: Mar. 24, 2005

(54) Planographic printing plate precursor

(75) Inventor: Takahiro Goto, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/942,137

(22) Filed: Sep. 16, 2004

(30) Foreign Application Priority Data
Sep. 19, 2003 (JP) 2003-327971

(51) Int. Cl. G03C 1/76

(52) U.S. Cl. 430/270.1

(57) ABSTRACT

In the planographic printing plate precursor of the present invention, a negative type recording layer is formed on an aluminum support which has been subjected to surface-roughening treatment and anodic oxidation treatment and has a central line average roughness Ra of 0.25 to 0.7 μm, and the recording layer comprises a compound (A) which can generate a radical by application of light or heat, a polymer (B) having on its side chain a phenyl group substituted with a vinyl group, a monomer (C) having two or more phenyl groups each substituted with a vinyl group, and an infrared absorbing agent (D).

### CROSS-REFERENCE TO RELATED APPLICATION

This application claims priority under 35 USC 119 from Japanese Patent Application No.2003-327971, the disclosure of which is incorporated by reference herein.

### BACKGROUND OF THE INVENTION

1. Field of the Invention

The present invention relates to a planographic printing plate precursor, and more specifically to a planographic printing plate precursor having a photosensitive negative type recording layer to which an infrared laser can be applied, the precursor being used for so-called direct plate-making by which a printing plate can be made directly upon the basis of digital signals from a computer or the like.

2. Description of the Related Art

In recent years, the development of lasers has been remarkable, and in particular, advances are being made with regard to increasing the output and decreasing the size of solid lasers and semiconductor lasers having an emission wavelength within the near infrared to infrared range. Accordingly, these lasers are very useful as exposure light sources used when direct plate-making is carried out on the basis of digital data from a computer or the like.

For negative planographic printing plate precursors for infrared lasers, which use, as an exposure-light source, an infrared laser having an emission wavelength within the above-mentioned infrared range, a recording method is used in which a polymerization reaction is caused in a recording layer by use of radicals generated by application of light or heat as an initiator, so as to cure exposed areas of the recording layer and thereby form image portions. In a case where the infrared absorbing agent is a dye, a method is used in which radicals are generated by electron-transfer from the dye which has absorbed infrared rays, causing polymerization reaction in the recording layer by use of the radicals as an initiator so as to cure exposed areas of the recording layer and thereby form image portions.

As image recording materials using such a recording method, there are disclosed a combination of resol resin, Novolak resin, an infrared absorbing agent and a photoacid generator (see, for example, Japanese Patent Application Laid-Open (JP-A) Nos. 7-20629 and 7-271029); and a combination of a specific polymer, a photoacid generator and a near infrared sensitizing dye (see, for example, JP-A Nos. 11-212252 and 11-231535). These photosensitive compositions or planographic printing plate precursors have a mechanism by which an acid generated by the photoacid generator is used as an initiator to cause a curing reaction and thereby form cured areas (i.e., image portions).

However, in the case of photosensitive compositions as described above in which image portions are formed by a curing reaction which uses a photopolymerization initiator or photoacid generator, it is difficult to provide a sufficiently high photosensitivity in the near infrared range. In particular, the compositions have insufficient photosensitivity to be applied to scanning exposure using infrared laser light.

In polymerization by use of a photopolymerization initiator or photoacid generator, there are many cases where cured areas having sufficient strength cannot be obtained only by exposure to light, and it is therefore necessary that heat treatment is conducted after the exposure or developing treatment so as to promote or complete the polymerization. Thus, the heating treatment is an important step of the plate-making process. However, this heating treatment not only decreases production efficiency, but is also a factor in destabilizing quality. For example, it is difficult to keep the difference in solubility between the exposed areas and non-exposed areas constant. If the heating is not sufficiently performed, the exposed-areas are also dissolved by a developer. Conversely, if the temperature generated by the heating is too high, the non-exposed areas are partially made insoluble so that sufficient development cannot be conducted. Thus, there is a concern that staining may occur in non-image portions.

In response to these problems, a photosensitive planographic printing plate precursor is suggested which neither requires heating treatment nor any overcoat layer and which can undergo scanning exposure to light (see, for example, JP-A No. 2001-290271). However, the sensitivity of this recording layer is insufficient.

Therefore, it has eagerly been desired to develop a planographic printing plate precursor which can record an image at a high sensitivity by exposure to infrared rays and is-excellent in both printing durability of image portions and stain resistance of non-image portions.

### SUMMARY OF THE INVENTION

In light of the above-mentioned problems, an object of the present invention is to provide a planographic printing plate precursor which has a high photosensitivity to infrared rays, exhibits no staining in non-image portions at the time of printing, and is excellent in printing durability.

The above-mentioned object of the invention has been achieved by the following planographic printing plate of the invention.

That is, the invention provides a planographic printing plate precursor comprising:
an aluminum support which has been subjected to surface-roughening treatment and anodic oxidation treatment and has a central line average roughness Ra of 0.25 to 0.7 μm; and
a negative type recording layer which is provided on the aluminum support and comprises a compound (A) which can generate a radical by application of light or heat, a polymer (B) having on its side chain a phenyl group substituted with a vinyl group, a monomer (C) having two or more phenyl groups each substituted with a vinyl group, and an infrared absorbing agent (D).

In a preferable embodiment of the invention, the aluminum support has a surface grain structure wherein a large wave structure having an average wavelength of 5 to 100 μm, a medium wave structure having an average aperture of 0.5 to 5 μm, and a small wave structure having an average aperture of 0.01 to 0.2 μm are superimposed, and the number of concave portions which are present in the surface and have a depth of 3 μm or more is from 10 to 60 per mm².

Although the operation of the invention is not entirely clear, it is presumed to be as follows.

It is presumed that, because the aluminum support used in the invention has an anodic oxidation film on its front surface side adjacent to the recording layer and further has the specific surface roughness, the surface is excellent in water-holding capacity and adhesiveness to image portions, whereby it is possible to achieve both stain resistance and printing durability at the time of printing.

### BRIEF DESCRIPTION OF THE DRAWINGS

FIG. 1 is a schematic view illustrating an example of a DRM interferential wave measuring device for measuring the dissolution behavior of a photosensitive layer.

FIG. 2 is a schematic view illustrating an example of the method for measuring the electrostatic capacity which is used to evaluate the permeability of a developer to a photosensitive layer.

FIG. 3 is a graph showing an example of a waveform chart of alternating current used in electrochemically surface-roughening treatment in the production of a support for a planographic printing plate precursor of the present invention.

FIG. 4 is a side view illustrating an example of a radial-form cell in electrochemically surface-roughening treatment using alternating current in the production of a support for a planographic printing plate precursor of the invention.

FIG. 5 is a schematic view of an anodic oxidation treatment device used in anodic oxidation treatment in the production of a support for a planographic printing plate precursor of the invention.

FIG. 6 is a side view schematically illustrating a brush graining step used in mechanically surface-roughening treatment in the production of a support for a planographic printing plate precursor of the invention.

### DETAILED DESCRIPTION OF THE INVENTION

The present invention is described in detail hereinafter.

[Planographic Printing Plate Precursor]

The planographic printing plate precursor of the invention comprises an aluminum support which has been subjected to surface-roughening treatment and anodic oxidation treatment and has a central line average roughness Ra of 0.25 to 0.7 μm, and a negative type recording layer which is provided on the aluminum support and comprises a compound (A) which can generate a radical by application of light or heat, a polymer (B) having on its side chain a phenyl group substituted with a vinyl group, a monomer (C) having two or more phenyl groups each substituted with a vinyl group, and an infrared absorbing agent (D).

In the recording layer of the planographic printing plate precursor of the invention, infrared rays absorbed by the infrared absorbing agent (D) are converted to heat. Due to the heat generated at this time and/or light, radicals are generated from the compound (A). The generated radicals are used as an initiator to cause chain polymerization reaction of molecules of the monomer (C), so that the recording layer is cured. Since the polymer (B) is used as a binder polymer in the invention, the generated radicals cause the generation of styryl radicals. The styryl radicals are then recombined with each other so that effective crosslinking is attained. Accordingly, the formed film has a hydrophobic property to give a surface having good development resistance. As a result, a cured film having superior property can be formed.

The following describes the components contained in the negative type recording layer of the planographic printing plate precursor of the invention one by one.

[Polymer (B) Having on its Side Chain a Phenyl Group Substituted with a Vinyl Group]

The polymer (B) having on its side chain a phenyl group substituted with a vinyl group is an important component for the invention, and this polymer is first described.

In the invention, the polymer having on its side chain a phenyl group substituted with a vinyl group (hereinafter referred to as the specific polymer as the case may be) is used as a binder polymer, and is a polymer wherein a phenyl group substituted with a vinyl group is bonded, directly or through a linking group, to a main chain. The linking group is not particularly limited, and an example thereof may be any group, any atom, or any group wherein these are combined with each other. The phenyl group may be substituted with a group which can be substituted, or an atom besides the vinyl group. Specific examples of the substituent or atom which can be introduced include halogen atoms, and carboxyl, sulfo, nitro, cyano, amide, amino, alkyl, aryl, alkoxy, and aryloxy groups.

Furthermore, the vinyl group may be substituted with a halogen atom, a carboxyl, sulfo, nitro, cyano, amide, amino, alkyl, aryl, alkoxy or aryloxy group, or the like.

The specific polymer is more specifically a polymer having on its side chain a group represented by the formula (1): 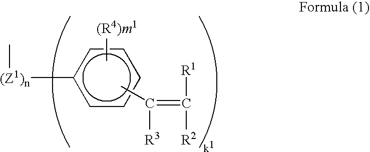
wherein Z¹ represents a linking group; R¹, R² and R³ each independently represent a hydrogen or halogen atom, a carboxyl, sulfo, nitro, cyano, amide, amino, alkyl, aryl, alkoxy or aryloxy group, or the like, which may be further substituted with an alkyl, amino, aryl, alkenyl, carboxyl, sulfo or hydroxyl group, or the like; R⁴ represents a group or atom which can be substituted; n is 0 or 1; m¹ is an integer from 0 to 4; and k¹ is an integer from 1 to 4.

The group represented by the formula (1) is more specifically described. The linking group represented by Z¹ may be one, or a combination of at least two, selected from the group consisting of an oxygen atom, a sulfur atom, an alkylene group, an alkenylene group, an arylene group, —N(R⁵)—, —C(O)—O—, —C(R⁶)═N—, —C(O)—, a sulfonyl group, a group illustrated below, a group containing a heterocyclic structure, and the like. R⁵ and R⁶ each independently represent a hydrogen atom, an alkyl group, an aryl group or the like. The above-mentioned linking group may have a substituent such as an alkyl group, an aryl group or a halogen atom.

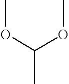

Examples of the heterocyclic structure which is contained in the linking group represented by Z¹ include nitrogen-containing heterocycles such as pyrrole, pyrazole, imidazole, triazole, tetrazole, isooxazole, oxazole, oxadiazole, isothiazole, thiazole, thiadiazole, thiatriazole, indole, indazole, benzimidazole, benzotriazole, benzoxazole, benzthiazole, benzselenazole, benzthiazodiazole, pyridine, piridazine, pyrimidine, pyrazine, triazine, quinoline, and quinoxaline rings; a furan ring; and a thiophene ring. These heterocyclic structures may each have a substituent such as an alkyl, amino, aryl, alkenyl, carboxyl, sulfo, or hydroxyl group.

Examples of the group or atom, which can be substituted, represented by R⁴ include halogen atoms, and carboxyl, sulfo, nitro, cyano, amide, amino, alkyl, aryl, alkoxy, and aryloxy groups. These groups or atoms may each have a substituent such as an alkyl, amino, aryl, alkenyl, carboxyl, sulfo or hydroxyl group.

Specific examples (K-1) to (K-20) of the group represented by the formula (1) are illustrated below. The group is not limited to these examples.

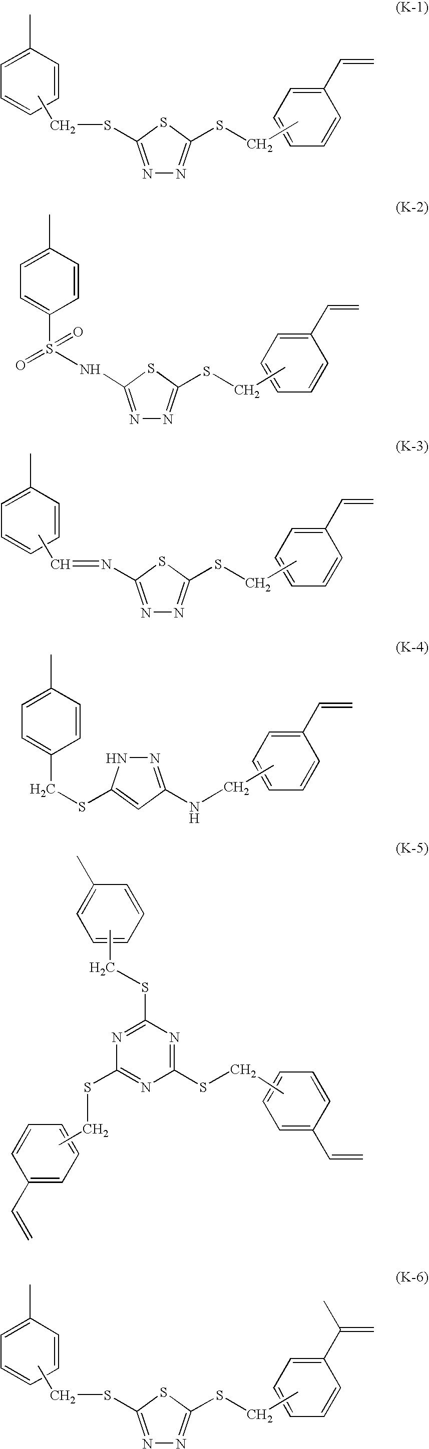

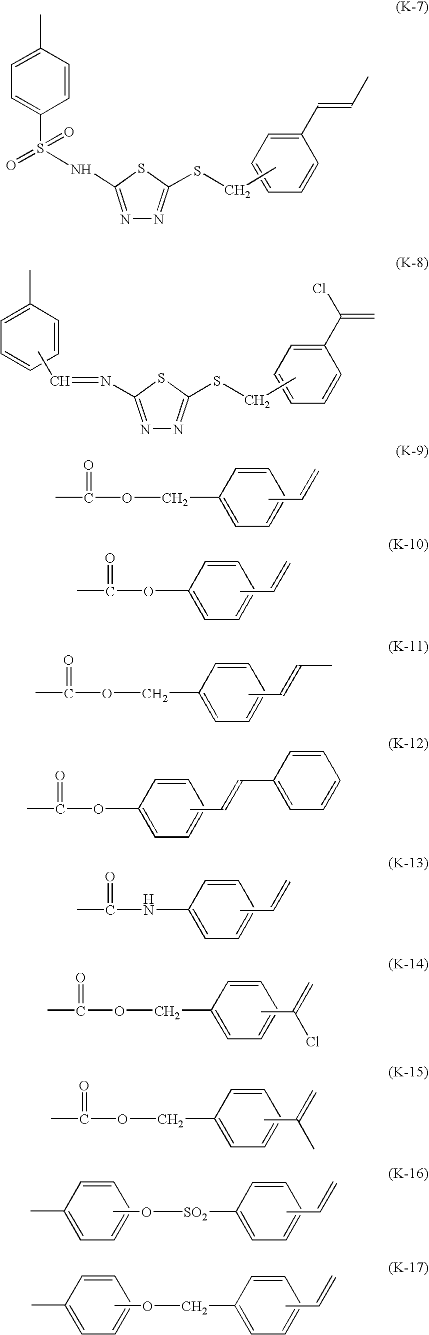

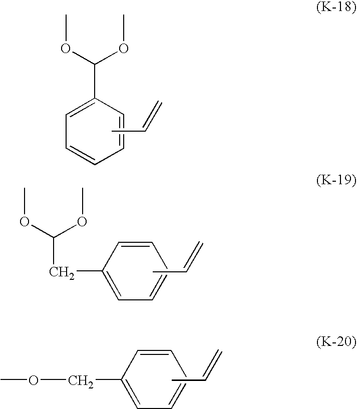

Of the groups represented by the formula (1), groups having the following structure are preferable: groups represented by the formula (1) wherein R¹ and R² are each a hydrogen atom, and R³ is a hydrogen atom or a lower alkyl group having 4 or less carbon atoms (for example, a methyl or ethyl group). Furthermore, preferable are groups wherein the linking group represented by Z¹ is a linking group containing a heterocyclic structure, and groups wherein k¹ is 1 or 2.

In a preferable embodiment of the specific polymer of the invention, the polymer has solubility in aqueous alkaline solution. It is therefore particularly preferable that the specific polymer of the invention is a copolymer which comprises, as copolymerizable components, a monomer which contains a carboxyl group as well as a monomer which contains the phenyl group which is substituted with a vinyl group (specifically, the group represented by the formula (1)).

In this case, the content of the monomer having this phenyl group (i.e., the group represented by the formula (1)), which is substituted with a vinyl group, in the composition of the copolymer is preferably from 1 to 95% by mass, more preferably from 10 to 80% by mass, and even more preferably from 20 to 70% by mass relative to the total mass of all components of the copolymer. If the content is less than 1% by mass, the effect of the introduction of the monomer having the phenyl group (i.e., the group represented by the formula (1)) may not be produced. If the content is 95% by mass or more, the copolymer may not be dissolved in aqueous alkali solution.

The content of the carboxyl-group-containing monomer in the copolymer is preferably from 5 to 99% by mass relative to the total mass of all components of the copolymer. If the content is less than 5% by mass, the copolymer may not be dissolved in aqueous alkali solution.

Preferable examples of the carboxyl-group-containing monomer, which is used as the copolymerizable component, include acrylic acid, methacrylic acid, 2-carboxylethyl acrylate, 2-carboxylethyl methacrylate, crotonic acid, maleic acid, fumaric acid, monoalkyl maleate, and monoalkyl fumarate, and 4-carboxylstyrene.

Other preferable examples of the copolymerizable component which is contained in this specific copolymer include polyacetal containing on its side chain benzoic acid, and polyvinyl alcohol modified with carboxylbenzaldehyde.

The polymer (B) of the invention may be a multi-component copolymer into which a monomer component different from the carboxyl-group-containing monomer is also incorporated. In this case, examples of the different monomer, which is incorporated into the copolymer, include:
styrene, and styrene derivatives, such as 4-methylstyrene, 4-hydroxylstyrene, 4-acetoxystyrene, 4-carboxylstyrene, 4-aminostyrene, chloromethylstyrene, and 4-methoxystyrene;
alkyl methacrylates, such as methyl methacrylate, ethyl methacrylate, butyl methacrylate, hexyl methacrylate, 2-ethylhexyl methacrylate, cyclohexyl methacrylate, and dodecyl methacrylate;
aryl methacrylates or alkylaryl methacrylate, such as phenyl methacrylate and benzyl methacrylate;
methacrylates having an alkyleneoxy group, such as 2-hydroxylethyl methacrylate, 2-hydroxylpropyl methacrylate, methacrylic acid monoester of methoxydiethylene glycol, methacrylic acid monoester of methoxypolyethylene glycol, and methacrylic acid monoester of polypropylene glycol;
methacrylates having an amino group, such as 2-dimethylaminoethyl methacrylate, and 2-diethylaminoethyl methacrylate;
acrylates corresponding to these methacrylates;
monomers having a phosphoric acid group, such as vinyl phosphonate;
monomers having an amino group, such as allylamine, and diallylamine;
monomers having a sulfonic acid group, such as vinylsulfonic acid and salts thereof, allylsulfonic acid and salts thereof, methacrylsulfonic acid and salts thereof, styrenesulfonic acid and salts thereof, and 2-acrylamide-2-methylpropanesulfonic acid and salts thereof;
monomers having a nitrogen-containing heterocycle, such as 4-vinylpyridine, 2-vinylpyridine, N-vinylimidazole, and N-vinylcarbazole;
monomers having a quaternary ammonium salt group, such as 4-vinylbenzyltrimethylammonium chloride, acryloyloxyethyltrimethylammonium chloride, methacryloyloxyethyltrimethylammonium chloride, a quaternary compound of dimethylaminopropylacrylamide by action of methyl chloride, a quaternary compound of N-vinylimidazole by action of methyl chloride, and 4-vinylbenzylpyridium chloride;
acrylamide, methacrylamide, and acrylamide and methacrylamide derivatives, such as dimethylacrylamide, diethylacrylamide, N-isopropylacryamide, diacetoneacrylamide, N-methylolacrylamide, N-methoxyethylacrylamide, and 4-hydroxyphenylacrylamide;
vinyl esters, such as acrylonitrile, methacrylonitrile, vinyl acetate, vinyl chloroacetate, vinyl propionate, vinyl butyrate, vinyl stearate, and vinyl benzoate;
vinyl ethers, such as methyl vinyl ether, and butyl vinyl ether; and
other monomers, such as phenylmaleimide, hydroxyphenylmaleimide, N-vinylpyrrolidone, acryloylmorpholine, tetrahydrofurfuryl methacrylate, vinyl chloride, vinylidene chloride, allyl alcohol, vinyltrimethoxysilane, and glycidyl methacrylate.

The content of any one of these monomers in the copolymer may be arbitrary as far as the above-mentioned preferable contents of the monomer having a group represented by the formula (1) and the carboxyl-group-containing monomer in the copolymer composition are maintained.

The weight-average molecular weight of the above-mentioned polymer has a preferable range, and the weight-average molecular weight of the polymer is preferably from 1,000 to 1,000,000, more preferably from 10,000 to 300,000.

Examples of the polymer having on its side chain a group represented by the formula (1) according to the invention are illustrated below. Numerical values in the structural formula each represent the percentage by mass of the corresponding repeating unit in the total mass of all components of the copolymer represented by the corresponding structural formula.

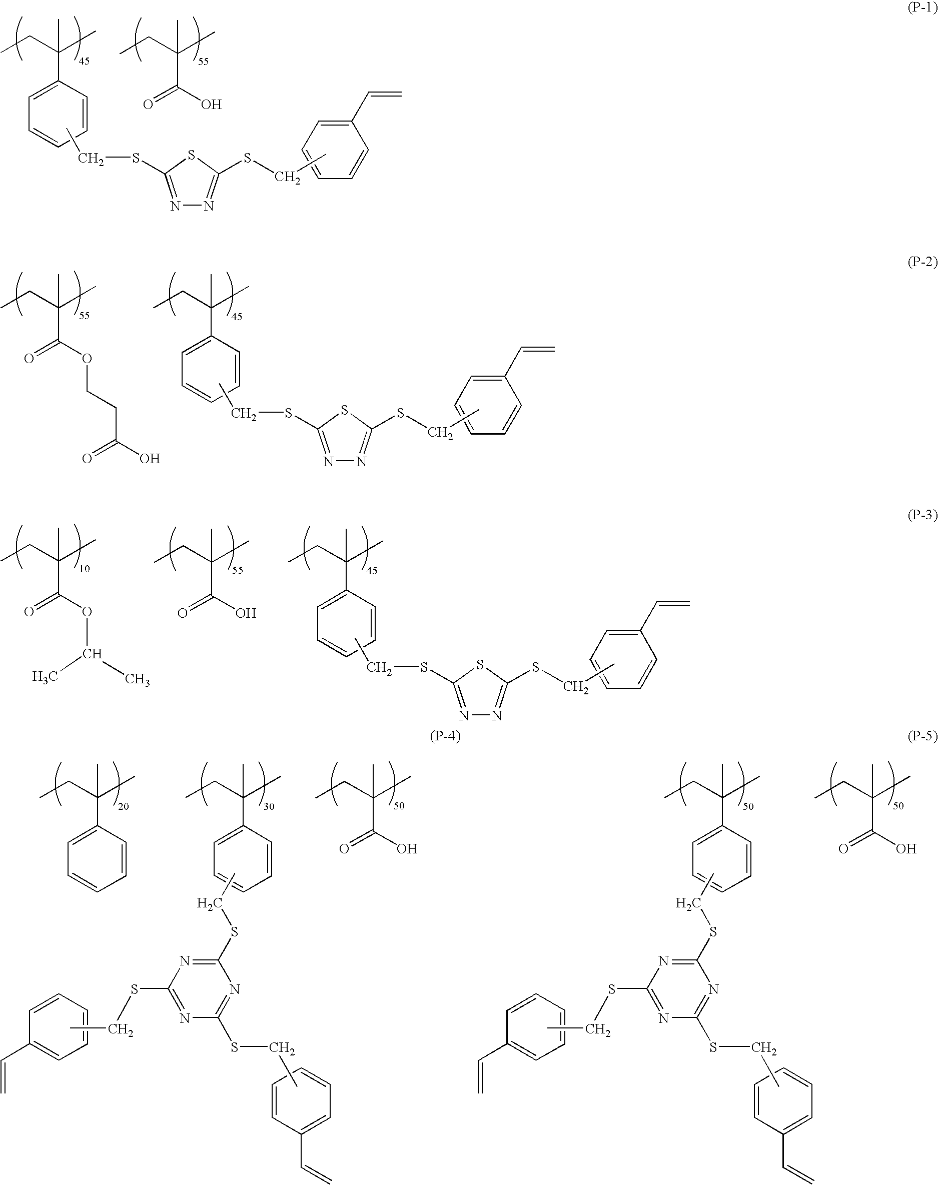

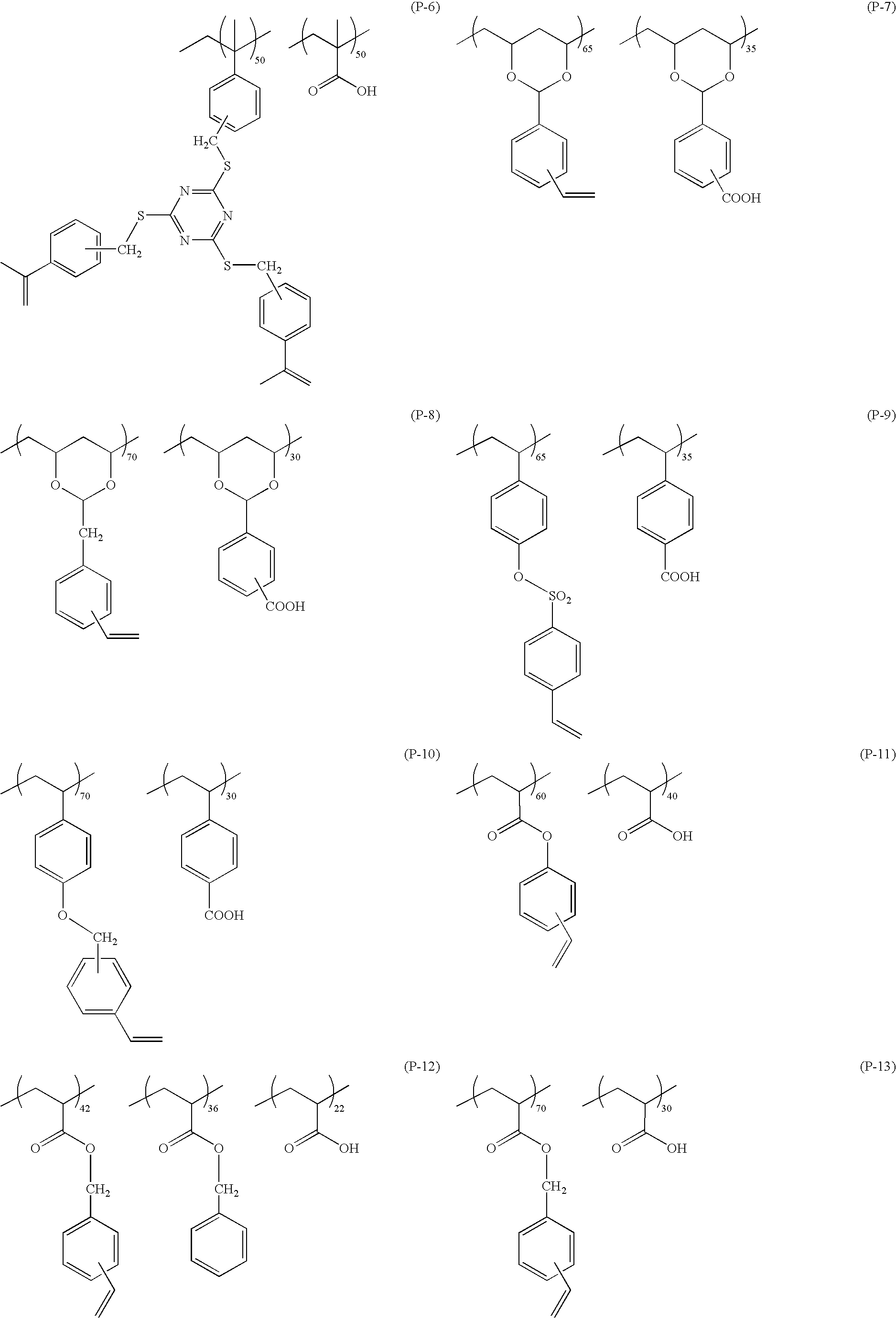

The specific polymers (B) used as binder polymers in the invention may be used alone or in combination of two or more thereof.

The binder polymer(s) is/are contained in the negative type recording layer in an amount of 10 to 90% by mass, and preferably 20 to 80% by mass relative to a total solid content of the recording layer from the viewpoints of the strength (film property and film strength) of image portions and image-formability.

The specific polymer (B) of the invention may be used in the state that the polymer (B) is mixed with any other binder polymer known in the prior art as far as the effect of the polymer (B) is not damaged.

[Compound (A) which can Generate Radicals by Light or Heat (Radical Generator)]

The compound (A) which can generate radicals by application of light or heat (hereinafter referred to as the “radical generator” as the case may be), which is used in the invention, may be any compound that can generate radicals by receiving light, heat or both of them.

Examples of the radical generator include organic boron salts, trihaloalkyl-substituted compounds (for example, trihaloalkyl-substituted, nitrogen-containing heterocyclic compounds, such as s-triazine compounds and oxadiazole derivatives; and trihaloalkylsulfonyl compounds), hexaarylbisimidazole, titanocene compounds, ketooxime compounds, thio compounds, and organic peroxide compounds.

Of these radical generators, organic boron salts and trihaloalkyl-substituted compounds are particularly preferable. An embodiment wherein an organic boron salt is used together with a trihaloalkyl-substituted compound is more preferable.

The organic boron anion which constitutes the organic boron salt may be represented by the following formula (2): 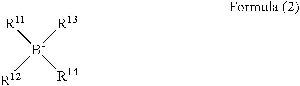
wherein R¹¹, R¹², R¹³, and R¹⁴, which may be the same or different, each represent an alkyl, aryl, aralkyl, alkenyl, alkynyl, cycloalkyl or heterocyclic group. A case wherein any one of R¹¹, R¹², R¹³ and R¹⁴ is an alkyl group and the others of these groups are aryl groups is particularly preferable.

The organic boron anion is present together with a cation that is combined with this anion to form a salt. Examples of the cation in this case include alkali metal ions, onium ions, and cationic sensitizing dyes.

Examples of the onium ions include ammonium, sulfonium, iodonium, and phosphonium ions.

In the case of using, as the organic boron salt, a salt of an organic boron anion and an alkali metal ion or onium ion, a sensitizing dye may be separately added, thereby giving photosensitivity to light-wavelengths which the dye absorbs to the recording layer. Since the planographic printing plate precursor of the invention has the recording layer photosensitive to infrared rays, the infrared absorbing agent (D), which will be detailed later, is used as a sensitizing dye.

In the case of using, as the organic boron salt, a salt composed of a cationic sensitizing dye and an organic boron anion as the counter ion of the dye, photosensitivity is given to the recording layer in accordance with the absorption wavelength of the cationic sensitizing dye. In the latter case, it is preferable that the recording layer further contains a salt of an alkali metal ion or onium ion and an organic boron anion.

In a preferred embodiment of the invention, the recording layer is made of a photosensitive composition wherein an organic boron salt is used as the radical generator and a dye which sensitizes the salt is also contained. The organic boron salt itself does not exhibit any sensitivity to wavelengths from visible light rays to infrared rays, but exhibits photosensitivity to these wavelengths due to the addition of a sensitizing dye such as the infrared absorbing agent (D) of the invention to the recording layer.

The organic boron salt used in the invention may be a salt containing the organic boron anion represented by the formula (2) illustrated above. The cation which is combined with the anion to form the salt is preferably an alkali metal ion or an onium ion. Particularly preferable examples of the salt include salts composed of this organic boron anion and an onium ion. Specific examples thereof include organic boron ammonium salts such as organic boron tetraalkylammonium salts, organic boron sulfonium salts such as organic boron triarylsulfonium salts, and organic boron phosphonium salts such as organic boron triarylalkylphosphonium salts.

Specific examples (BC-1) to (BC-6) of the particularly preferable organic boron salts are illustrated below.

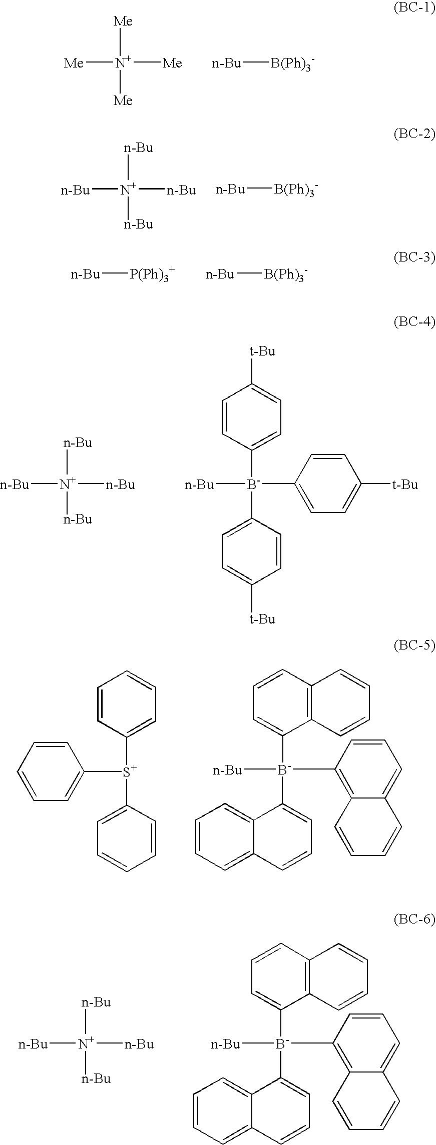

Other preferable examples of the radical generator of the invention include trihaloalkyl-substituted compounds. The trihaloalkyl-substituted compounds are specifically compounds which each have in the molecule thereof at least one trihaloalkyl group such as a trichloromethyl or tribromomethyl group. Preferable examples thereof include compounds wherein a trihaloalkyl group is bonded to a nitrogen-containing heterocyclic group, such as s-triazine derivatives and oxadiazole compounds; and trihaloalkylsulfonyl compounds, wherein a trihaloalkyl group is bonded through a sulfonyl group to an aromatic ring or a nitrogen-containing heterocyclic ring.

Particularly preferable specific examples (T-1) to (T-15) of the compounds wherein a trihaloalkyl group is bonded to a nitrogen-containing heterocyclic group, and particularly preferable specific examples (BS-1) to (BS-10) of the trihaloalkylsulfonyl compounds are illustrated below.

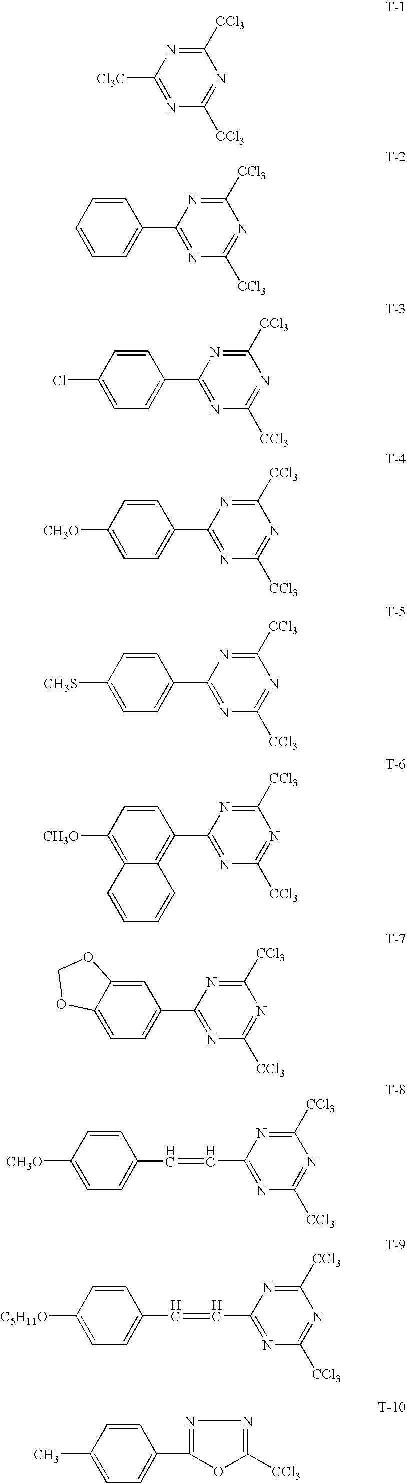

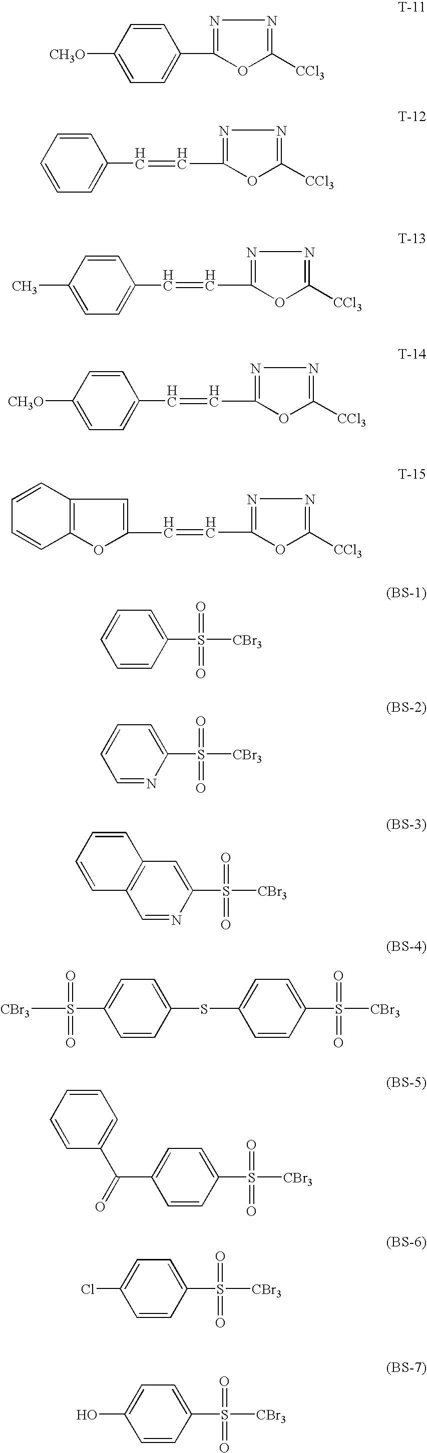

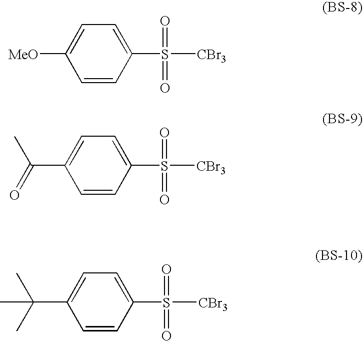

Further preferable examples of the radical generator of the invention are organic peroxides. Examples of the organic peroxides include cumenehydroperoxide, tert-butylhydroperoxide, dichloroperoxide, di-tert-butylperoxide, benzoylperoxide, acetylperoxide, lauroylperoxide, and a compound having a structure by the following:

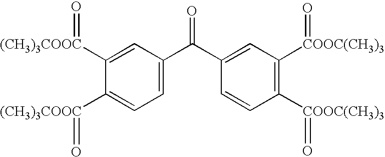

The content of the radical generator (A) is preferably from 1 to 100% by mass, more preferably from 1 to 40% by mass relative to the amount of the above-mentioned polymer (B).

[Monomer (C) Having Two or More Phenyl Groups each Substituted with a Vinyl Group]

In the invention, the monomer (C) having two or more phenyl groups each substituted with a vinyl group (hereinafter referred to as the “specific monomer”), which is used as a polymerizable compound, can form a negative type recording layer having a high sensitivity and requiring no heating treatment, because crosslinking is effectively carried out due to recombination of styryl radicals with each other, the styryl radicals being generated by radicals generated by the radical generator (A).

A typical example of the specific monomer in the invention is a compound represented by the following formula (3): 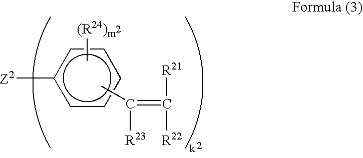
wherein Z² represents a linking group; R²¹, R²² and R²³ each independently represent a hydrogen or halogen atom, a carboxyl, sulfo, nitro, cyano, amide, amino, alkyl, aryl, alkoxy or aryloxy group, or the like, which may be further substituted with an alkyl, amino, aryl, alkenyl, carboxyl, sulfo or hydroxyl group, or the like; R²⁴ represents a group or atom which can be substituted; m² is an integer from 0 to 4; and k² is an integer greater than or equal to 2.

The compound represented by the formula (3) is more specifically described. The linking group represented by Z² may be one, or a combination of at least two, selected from the group consisting of an oxygen atom, a sulfur atom, an alkylene group, an alkenylene group, an arylene group, —N(R⁵)—, —C(O)—O—, —C(R⁶)═N—, —C(O)—, a sulfonyl group, a group containing a heterocyclic structure, a group containing a benzene ring structure, and the like. R⁵ and R⁶ each independently represent a hydrogen atom, an alkyl group, an aryl group or the like. The linking group may have a substituent such as an alkyl group, an aryl group, or a halogen atom.

Examples of the heterocyclic structure which is contained in the linking group represented by Z² include nitrogen-containing heterocycles such as pyrrole, pyrazole, imidazole, triazole, tetrazole, isooxazole, oxazole, oxadiazole, isothiazole, thiazole, thiadiazole, thiatriazole, indole, indazole, benzimidazole, benzotriazole, benzoxazole, benzthiazole, benzselenazole, benzthiazodiazole, pyridine, piridazine, pyrimidine, pyrazine, triazine, quinoline, and quinoxaline rings; a furan ring; and a thiophene ring. These heterocyclic structures may each have a substituent such as an alkyl, amino, aryl, alkenyl, carboxyl, sulfo, or hydroxyl group.

Examples of the group or atom, which can be substituted, represented by R²⁴ include halogen atoms, and carboxyl, sulfo, nitro, cyano, amide, amino, alkyl, aryl, alkoxy, and aryloxy groups. These groups or atoms may each have a substituent such as an alkyl, amino, aryl, alkenyl, carboxyl, sulfo or hydroxyl group.

Of the compounds represented by the formula (3), compounds having any one of structures represented by the following are preferable. That is, preferable are compounds wherein R²¹ and R²² in the formula (3) are each a hydrogen atom, R²³ is a hydrogen atom or a lower alkyl group having 4 or less carbon atoms (such as a methyl or ethyl group), and k² is an integer from 2 to 10.

Specific examples (C-1) to (C-11) of the compound represented by the formula (3) are illustrated below. The compound is not limited to these specific examples.

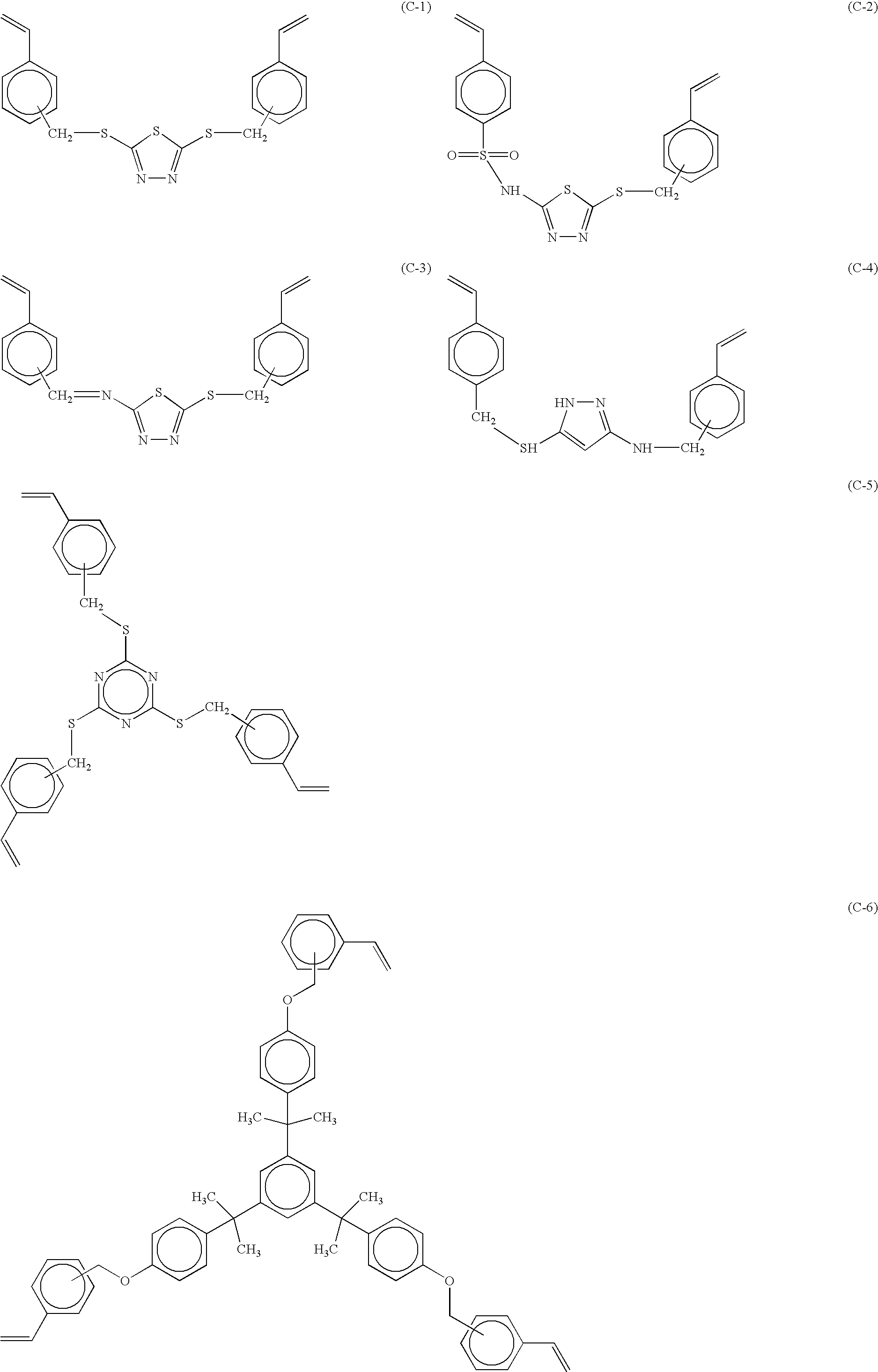

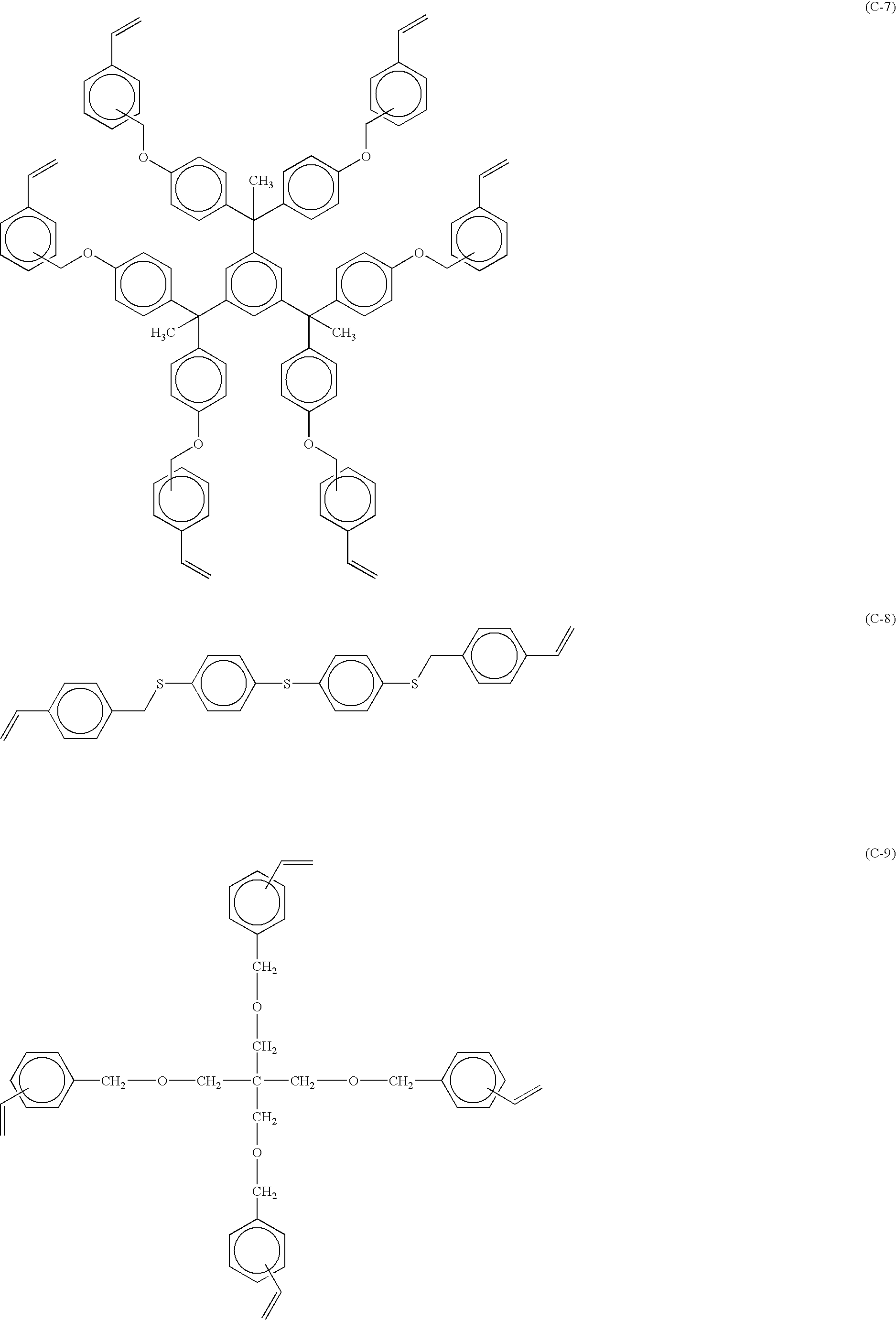

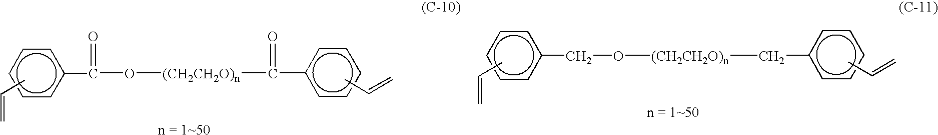

The specific monomers (C) as the polymerizable compounds used in the invention may be used alone or in combination of two or more thereof.

The specific monomer(s) is/are contained in the negative type recording layer in an amount of 0.01 to 10 parts by mass, preferably 0.05 to 1 part by mass per 1 part by mass of the polymer (B) (i.e., the binder polymer).

The specific monomer (C) of the invention may be used in the state that the monomer (C) is mixed with some other polymerizable compound known in the prior art as far as the effect thereof is not damaged.

[Infrared Absorbing Agent (D)]

The infrared absorbing agent used in the invention has a function of converting absorbed infrared rays to heat, and a function of generating excited electrons. When the infrared absorbing agent absorbs light, the radical generator (A) decomposes to generate radicals.

The infrared absorbing agent used in the invention is a dye or pigment which has an absorption maximum at a wavelength of 760 to 1200 nm.

The dye may be a commercially available dye or a known dye described in documents, such as “Dye Handbook” (edited by the Society of Synthesis Organic Chemistry, Japan, and published in 1970). Specific examples of the dye include azo dyes, metal complex salt azo dyes, pyrazolone azo dyes, naphthoquinone dyes, anthraquinone dyes, phthalocyanine dyes, carbonium dyes, quinoneimine dyes, methine dyes, cyanine dyes, squarylium dyes, pyrylium dyes, and metal thiolate complexes.

Preferable examples of the dye include cyanine dyes described in JP-A Nos. 58-125246, 59-84356, 59-202829 and 60-78787; methine dyes described in JP-A Nos. 58-173696, 58-181690 and 58-194595; naphthoquinone dyes described in JP-A Nos. 58-112793, 58-224793, 59-48187, 59-73996, 60-52940 and 60-63744; squarylium dyes described in JP-A No. 58-112792; and cyanine dyes described in GB Patent No. 434,875.

Other preferable examples thereof include near infrared absorbing sensitizers described in U.S. Pat. No. 5,156,938; substituted arylbenzo(thio)pyrylium salts described in U.S. Pat. No. 3,881,924; trimethinethiapyrylium salts described in JP-A No. 57-142645 (U.S. Pat. No. 4,327,169); pyrylium compounds described in JP-A Nos. 58-181051, 58-220143, 59-41363, 59-84248, 59-84249, 59-146063 and 59-146061; cyanine dyes described in JP-A No. 59-216146; pentamethinethiopyrylium salts described in U.S. Pat. No. 4,283,475; pyrylium compounds described in Japanese Patent Application Publication (JP-B) No. 5-13514 and JP-A No. 5-19702; and near infrared absorbing dyes represented by the formula (I) or (II) described in U.S. Pat. No. 4,756,993.

Specific examples (S-1) to (S-14) of the dye which is preferably used as the infrared absorbing agent are illustrated below. The dye is not limited to these examples.

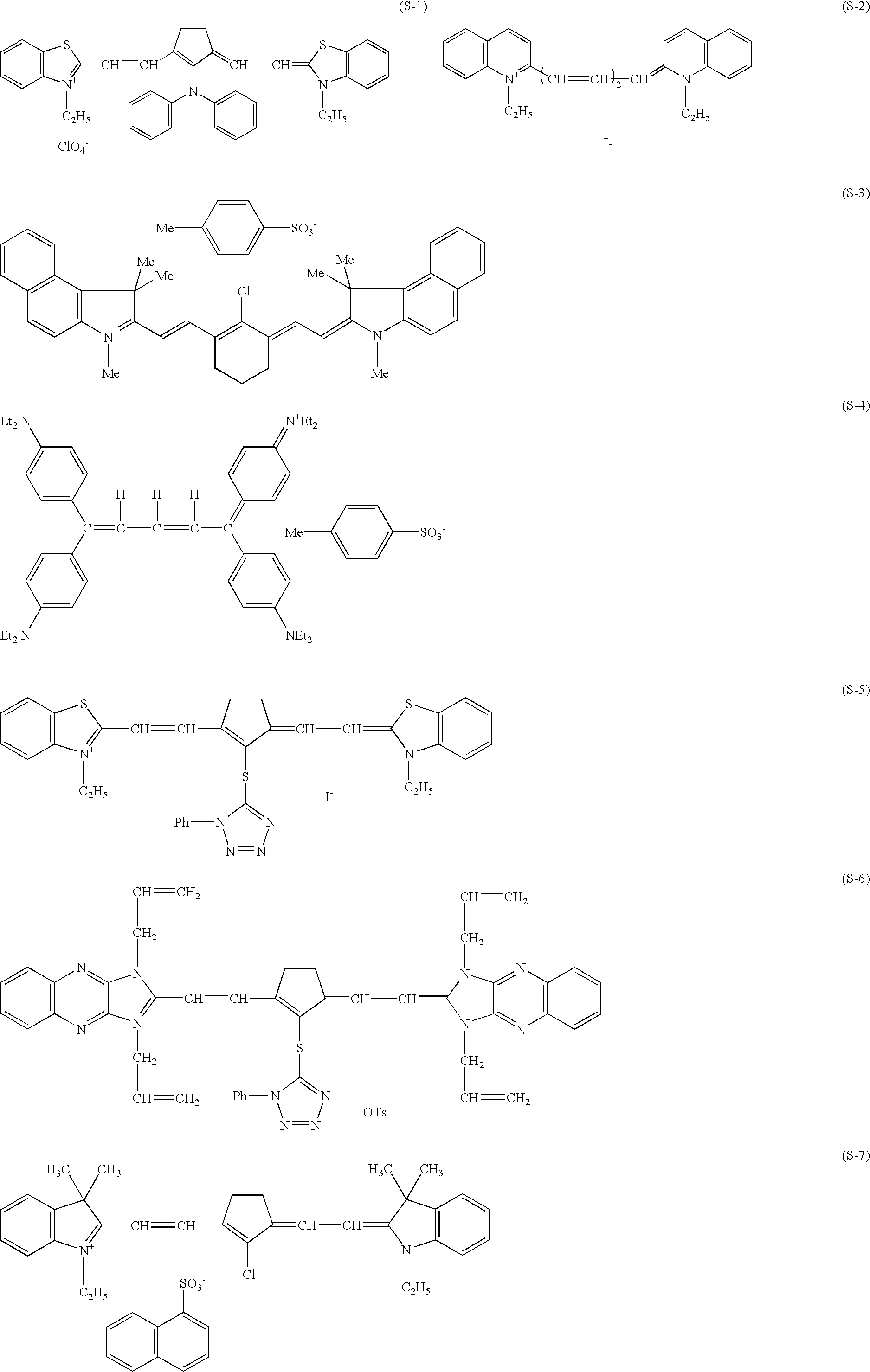

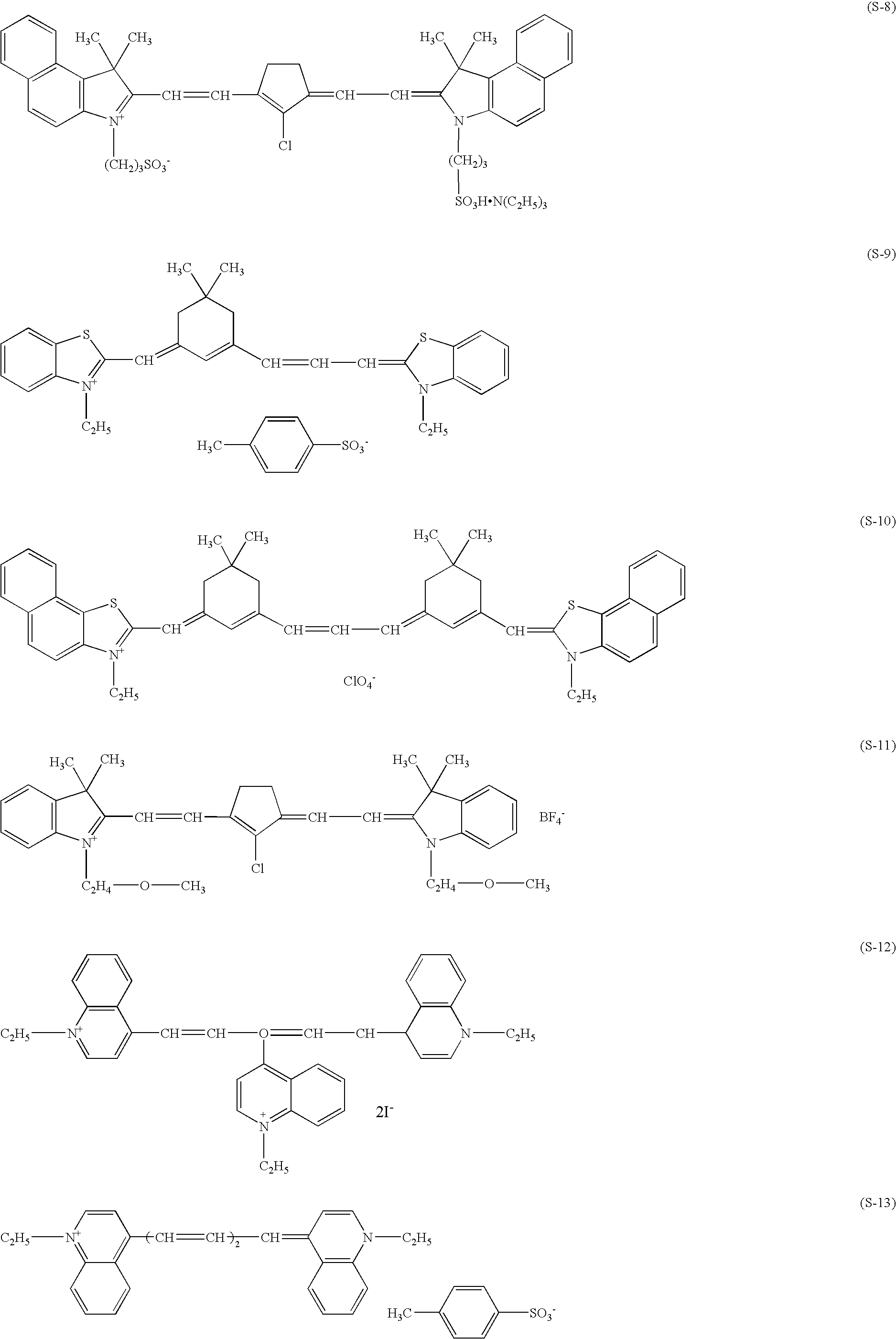

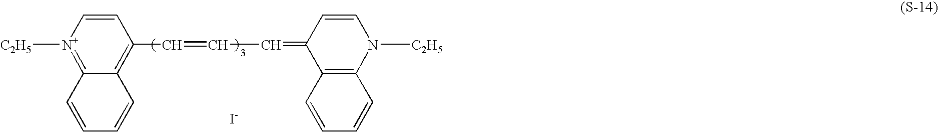

Similarly, infrared absorbing agents wherein the counter anion of any one of the infrared absorbing agents (cationic sensitizing dyes) illustrated above is substituted with an organic boron anion as described above can be used.

These dyes may be used alone or in combination of two or more thereof.

The content of the dye as the infrared absorbing agent is suitably from about 3 to 300 mg, more suitably from 10 to 200 mg per 1 square meter of the negative type recording layer.

The pigment used in the invention may be a commercially available pigment or a pigment described in documents such as Color Index (C.I.) Handbook, “Latest Pigment Handbook” (edited by Japan Pigment Technique Association, and published in 1977), “Latest Pigment Applied Technique” (by CMC Publishing Co., Ltd. in 1986), and “Printing Ink Technique” (by CMC Publishing Co., Ltd. in 1984).

Examples of the pigment include black pigments, yellow pigments, orange pigments, brown pigments, red pigments, violet pigments, purple pigments, blue pigments, green pigments, fluorescent pigments, metal powder pigments, and polymer-bonded dyes. Specifically, the following can be used: insoluble azo pigments, azo lake pigments, condensed azo pigments, chelate azo pigments, phthalocyanine pigments, anthraquinone pigments, perylene and perynone pigments, thioindigo pigments, quinacridone pigments, dioxazine pigments, isoindolinone pigments, quinophthalone pigments, dyeing lake pigments, azine pigments, nitroso pigments, nitro pigments, natural pigments, fluorescent pigments, inorganic pigments, carbon black and the like. Of these pigments, carbon black is preferable.

These pigments may be used with or without surface treatment. Examples of the surface treatment include a method of coating the surface of the pigments with resin or wax; a method of adhering a surfactant onto the surface; and a method of bonding a reactive material (such as a silane coupling agent, an epoxy compound, or a polyisocyanate) to the surface. The surface treatment methods are described in “Nature and Application of Metal Soap” (Saiwai Shobo), “Printing Ink technique” (by CMC Publishing Co., Ltd. in 1984), “Latest Pigment Applied Technique” (by CMC Publishing Co., Ltd. in 1986), and so on.

The particle size of the pigment is preferably from 0.01 to 10 μm, more preferably from 0.05 to 1 μm, and even more preferably from 0.1 to 1 μm. When the particle size is within the preferable range, a superior dispersion stability of the pigment in the coating solution for the negative type recording layer can be obtained and the resultant negative type recording layer is homogeneous.

The method for dispersing the pigment may be a known dispersing technique used to produce ink or toner. Examples of the dispersing machine used in the method include an ultrasonic disperser, a sand mill, an attriter, a pearl mill, a super mill, a ball mill, an impeller, a disperser, a KD mill, a colloid mill, a dynatron, a three-roll mill, and a pressing kneader. Details thereof are described in “Latest Pigment Applied Technique” (by CMC Publishing Co., Ltd. in 1986).

The pigment serving as the infrared absorbing agent can be contained in the negative type recording layer in an amount of 0.01 to 50% by mass, preferably 0.1 to 10% by mass, and more preferably 0.1 to 10% by mass relative to the total solid content of the negative type recording layer, from the viewpoints of the uniformity in the recording layer and the durability of the photosensitive layer.

It is allowable to add, to the negative type recording layer of the planographic printing plate precursor of the invention, other components suitable for the purpose of the precursor, the production process thereof, and so on besides the essential components (A) to (D). Preferable examples of the components are described hereinafter.

[Polymerization Inhibitor]

It is desirable to add, to the negative type recording layer of the invention, a small amount of a thermopolymerization inhibitor in order to inhibit unnecessary thermopolymerization of the specific monomer (C) (the polymerizable compound), that is, a compound having an ethylenic unsaturated double bond, which is polymerizable, in the production or storage of the negative type recording layer. Suitable examples of the thermopolymerization inhibitor include hydroquinone, p-methoxyphenol, di-t-butyl-p-cresol, pyrogallol, t-butylcatechol, benzoquinone, 4,4′-thiobis(3-methyl-6-t-butylphenol), 2,2 ′-methylenebis(4-methyl-6-t-butylphenol), and a cerium (III) salt of N-nitrosophenylhydroxyamine. The content of the thermopolymerization inhibitor is preferably from about 0.01 to 5% by mass relative to the total solid content of the negative type recording layer.

If necessary, a higher fatty acid derivative, such as behenic acid or behenic amide, may be added to the coating solution for the negative type recording layer in order to prevent polymerization inhibition based on oxygen, whereby the derivative is unevenly distributed in the surface of the negative type recording layer in the step of drying the coating solution after the application thereof. The content of the higher fatty acid derivative is preferably from about 0.5 to 10% by mass relative to the total solid content of the negative type recording layer.

[Colorant]

A colorant for coloration may be added to the negative type recording layer in the invention, thereby making it possible to improve the visibility of the printing plate made up from the precursor, the suitability thereof for image-density measuring devices, and other capabilities, that is, the so-called plate-examinable properties. The colorant is preferably a dye or a pigment. Specific examples thereof include pigments such as phthalocyanine pigments, azo pigments, carbon black, and titanium oxide; and dyes such as ethyl violet, crystal violet, azo dyes, anthraquinone dyes, and cyanine dyes. The content of the dye or pigment as the colorant is preferably from about 0.5 to 5% by mass relative to the total solid content of the negative type recording layer. In the case of the dye, it is preferable that the dye does not contain any halogen ion as the counter ion thereof.

[Other Additives]

It is acceptable to use, in the polymerizable composition for the negative type recording layer, additives for giving various properties, such as an oxygen-removing agent, such as phosphine, phosphonate or phosphite, a reducing agent, a color-fading inhibitor, a surfactant, a plasticizer, an antioxidant, an ultraviolet absorbing agent, an antifungal agent and an antistatic agent, in accordance with purpose in the state that the additives are mixed with a diluting solvent or the like.

It is also acceptable to add, to the polymerizable composition, known additives such as an inorganic filler for improving physical properties of the cured film, a plasticizer and a sensitizing agent for improving ink receptivity of a surface the negative type recording layer.

Examples of the plasticizer include dioctyl phthalate, didodecyl phthalate, triethylene glycol dicaprate, dimethyl glycol phthalate, tricresyl phosphate, dioctyl adipate, dibutyl cebacate, and triacetylglycerin. In general, the plasticizer can be added at a ratio of 10% or less by mass of the total mass of the specific polymer (binder polymer) (B) and the specific monomer (C).

A UV initiator or a thermally crosslinking agent can be added to the polymerizable composition in order to enhance the effect of heating and exposure to light after development, thereby improving the film strength (printing durability), which will be detailed later.

In order to promote the polymerization of the polymerizable composition, a polymerization promoter or a chain transfer agent can be added to the polymerizable composition. Typical examples thereof include amines, thiols, and disulfides. Specific examples thereof include N-phenylglycine, triethanolamine, and N,N-diethylaniline.

When the negative type recording layer is formed by coating in the invention, the components for the recording layer are dissolved in one or more out of various organic solvents and then the resultant solution is applied onto a support or an intermediate layer, which will be detailed later.

Examples of the solvent used at this time include acetone, methyl ethyl ketone, cyclohexane, ethyl acetate, ethylene dichloride, tetrahydrofuran, toluene, ethylene glycol monomethyl ether, ethylene glycol monoethyl ether, ethylylene glycol dimethyl ether, propylene glycol monomethyl ether, propylene glycol monoethyl ether, acetylacetone, cyclohexanone, diacetone alcohol, ethylene glycol monomethyl ether acetate, ethylene glycol ethyl ether acetate, ethylene glycol monoisopropyl ether, ethylene glycol monobutyl ether acetate, 3-methoxypropanol, methoxymethoxyethanol, diethylene glycol monomethyl ether, diethylene glycol monoethyl ether, diethylene glycol dimethyl ether, diethylene glycol diethyl ether, propylene glycol monomethyl ether acetate, propylene glycol monoethyl ether acetate, 3-methoxypropyl acetate, N,N-dimethylformamide, dimethylsulfoxide, y-butyrolactone, methyl lactate, ethyl lactate, and dioxane. These solvents may be used alone or in a mixture form. The concentration of solids in the coating solution is suitably from 2 to 50% by mass.

The applied amount of the coating solution for the negative type recording layer (or the thickness of the layer) produces effects mainly on the sensitivity and the developability of the negative type recording layer, and the strength and the printing durability of the layer exposed. It is desirable to select the amount appropriately in accordance with the purpose.

For the planographic printing plate precursor for scanning exposure, which is a principal target of the invention, the applied amount is preferably from about 0.1 to 10 g/m², more preferably from 0.5 to 5 g/m², as mass obtained after the solution is dried, from the viewpoints of the printing durability, the sensitivity of the recording layer and the like.

(Physical Properties of the Negative Type Recording Layer)

Regarding physical properties of the negative type recording layer in the invention, the developing rate of its non-exposed portions for alkali developer having a pH of 10 to 13.5 is preferably 80 nm/sec or more, and the permeating rate of the alkali developer in its exposed portions is preferably 100 nF/sec or less.

The developing rate of the non-exposed portions for alkali developer having a pH of 10 to 13.5 is a value obtained by dividing the film thickness (m) of the negative type recording layer by the time (sec) necessary for developing the layer, and the permeating rate of the alkali developer is a value representing the change rate of the electrostatic capacity (F) of the negative type recording layer formed on a conductive support in the case that the recording layer is immersed in the developer.

The following describes methods for measuring “the developing rate for alkali developer” and “the permeating rate of alkali developer” in the invention in detail.

[Measurement of the Developing Rate for Alkali Developer]

The developing rate of the negative type recording layer for alkali developer is a value obtained by dividing the film thickness (m) of the negative type recording layer by the time (sec) necessary for developing the layer.

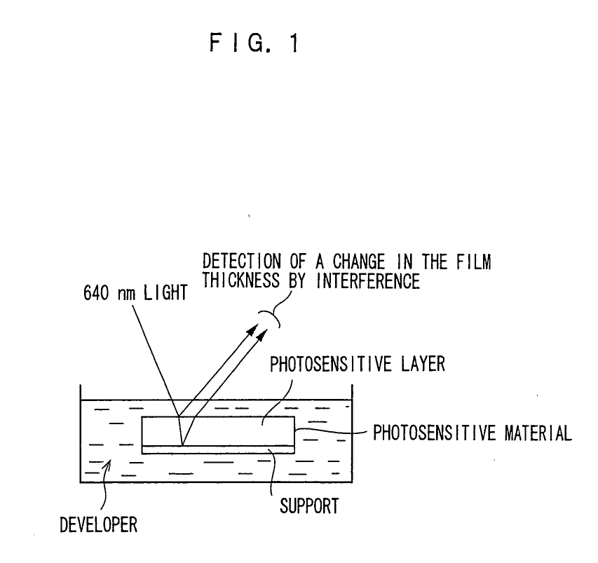

As illustrated in FIG. 1, in the method for measuring the developing rate in the invention, the non-exposed negative type recording layer formed on an aluminum support is immersed into an alkali developer (30° C.) having a constant pH ranging from 10 to 13.5, and then the dissolution behavior of the negative type recording layer is examined with a DRM interferential wave measuring device. In FIG. 1, this device, for measuring the dissolution behavior of the negative type recording layer, is schematically illustrated. In the invention, light having a wavelength of 640 nm is used to detect a change in the film thickness on the basis of interference. In the case that the development behavior is based on non-swelling development from the surface of the negative type recording layer, the film thickness gradually becomes thinner with an increase in time for the development. An interferential wave corresponding to the thickness is obtained. In the case of swelling development (film-released dissolution), the film thickness is changed by permeation of the developer. Accordingly, a clear interferential wave is not obtained.

Under this condition, the measurement is continued to obtain the time until the negative type recording layer is completely removed so as to make the film thickness to zero (development-completed time (s)) and the film thickness (μm) of the negative type recording layer. From the following equation, the developing rate can be calculated:
Development rate (of non-exposed portions)=Negative type recording layer thickness (μm)/Development-completed time (sec)

As this developing rate is larger, the film is more easily removed with the developer and the developability of the film is better.

[Measurement of the Permeating Rate of Alkali Developer]

The permeating rate of alkali developer is a value representing the change rate of the electrostatic capacity (F) of the negative type recording layer formed on a conductive support in the case that the recording layer is immersed in the developer.

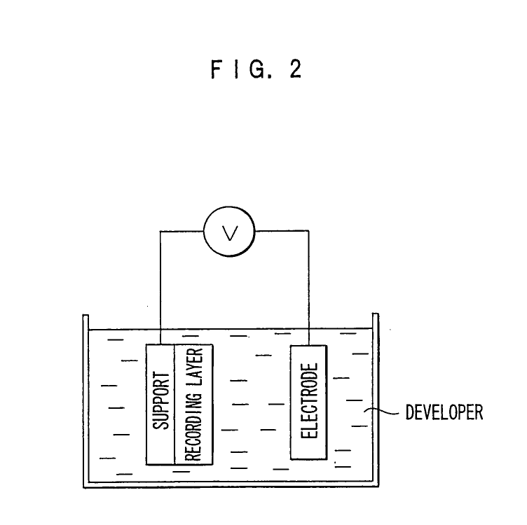

As illustrated in FIG. 2, in the method for measuring the electrostatic capacity, which is an index of the permeability of the developer in the invention, the negative type recording layer formed on an aluminum support and cured by exposure at a given exposure quantity is immersed as one electrode in an alkali developer (28° C.) having a constant pH ranging from 10 to 13.5, and further the aluminum support is connected to a conductive lead. As the other electrode, an ordinary electrode is used. A voltage is applied to this system. After the application of the voltage, the developer permeates the interface between the support and the negative type recording layer increasingly as the time for the immersion passes. Thus, the electrostatic capacity changes.

From the time (s) required until this electrostatic capacity gets constant and the film thickness (μm) of the negative type recording layer, the developer permeating rate can be obtained:
Developer permeating rate (of exposed-portions)=Negative type recording layer thickness (μm)/Time (s) required until the electrostatic capacity gets constant

As this permeating rate is smaller, the permeability of the developer is lower.

As preferable physical properties of the negative type recording layer in the invention, it is preferable that the developing rate, according to the above-described measurement, of its non-exposed portions by alkali developer having a pH of 10 to 13.5 is from 80 to 400 nm/sec, and the permeating rate, according to the above-described measurement, of the alkali developer in the negative type recording layer is 90 nF/sec or less. It is more preferable that the developing rate, according to the above-described measurement, of the non-exposed portions by alkali developer having a pH of 10 to 13.5 is from 90 to 200 nm/sec, and the permeating rate, according to the above-described measurement, of the alkali developer in the negative type recording layer is 80 nF/sec or less. The upper limit of the developing rate and the lower limit of the permeating rate are not particularly limited. However, considering the balance between the two, it is preferable that the developing rate of the non-exposed portions is from 90 to 200 nm/sec and the permeating rate of the alkali developer in the negative type recording layer is 80 nF/ sec or less.

The developing rate of the non-exposed portions of the negative type recording layer or the permeating rate of the alkali developer in the negative type recording layer after the layer is cured can be controlled by a usual method. Typical and useful examples thereof include a method of adding a hydrophilic compound in order to improve the developing rate of the non-exposed portions, and a method of adding a hydrophobic compound in order to suppress the permeation of the developer into the exposed portions.

The developing rate of the negative type recording layer according to the invention or the permeation rate of the developer can be controlled into the above-mentioned preferable range by adjusting the contents of the respective components which constitute the negative type recording layer. These rates are preferably set into the above-mentioned physical property ranges.

It is essential that the planographic printing plate precursor of the invention comprises the negative type recording layer on an aluminum support having a specific surface which will be detailed later. Any other layer, such as an intermediate layer or a back coat layer, can be formed in the precursor in accordance with the purpose thereof as far as the advantageous effects of the invention are not damaged.

The intermediate layer (undercoat layer) may be formed in the planographic printing plate precursor of the invention in order to improve the adhesiveness between the negative type recording layer and the support or the stain resistance. Specific examples of the intermediate layer include layers described in JP-B No. 50-7481, JP-A Nos. 54-72104, 59-101651, 60-149491, 60-232998, 3-56177, 4-282637, 5-16558, 5-246171, 7-159983, 7-314937, 8-202025, 8-320551, 9-34104, 9-236911, 9-269593, 10-69092, 10-115931, 10-161317, 10-260536, 10-282682, 11-84674, 10-069092, 10-115931, 11-038635, 11-038629, 10-282465, 10-301262, 11-024277, 11-109641, 10-319600, 11-084674, 11-327152, 2000-010292, 2000-235254, 2000-352824, and 2001-209170.

[Back Coat Layer]

The back coat layer may be formed on the rear face of the support in the planographic printing plate precursor of the invention if necessary. This back coat layer is preferably a coating layer made of a metal oxide obtained by hydrolyzing and polycondensing an organic or inorganic metal compound described in JP-A Nos. 5-45885 and 6-35174.

A particularly preferable example of this coating layer is a coating layer made of a metal oxide produced from an alkoxy compound of silicone, such as Si(OCH₃)₄, Si(OC₂H₅)₄, Si(OC₃H₇)₄ or Si(OC₄H₉)₄, which is inexpensive and is easily available and the layer made of thereof is superior in development resistance.

[Support]

Regarding the support of the planographic printing plate precursor of the invention, it is indispensable that its surface on which the negative type recording layer is formed has a central line average roughness Ra of 0.25 to 0.7 μm. This central line average roughness Ra is preferably from 0.30 to 0.60 μm. When the central line average roughness Ra is within this range, the density of irregularities in the support surface is satisfactorily kept, excellent developability can be obtained and further a deterioration in the developability, which is caused by undesired polymerization reaction generated at the time of storage, is suppressed. Thus, an advantage that stability thereof over time is good is given. When the roughness Ra is within this range, unevenness in the film thickness of the recording layer is not generated so that no bad effects are produced on the image-formability or the film-strength of the recording layer. In addition thereto, superior adhesiveness between the support and the recording layer can be attained.

In a more preferable embodiment, the grain structure of the surface of the support is a structure wherein a large wave structure having an average wavelength of 5 to 100 μm, a medium wave structure having an average aperture of 0.5 to 5 μm, and a small wave structure having an average aperture of 0.01 to 0.2 μm are superimposed, and the number of concave portions which are present in the surface and have a depth of 3 μm or more is from 10 to 60 per mm².

In the invention, a method for measuring the central line average roughness Ra of the surface is as follows:

A profilometer (for example, Surfcom 575, manufactured by Tokyo Seimitsu Co.) is used to carry out two-dimensional roughness measurement, thereby measuring the average roughness of the surface prescribed in ISO 4287 five times. The average thereof is defined as the central line average roughness Ra.

Conditions for the two-dimensional roughness measurement are as follows:
Cutoff value: 0.8 mm, inclination correction: FLAT-ML,
measurement length: 3 mm, lengthwise magnification: 10000 powers,
scanning rate: 0.3 mm/sec, and tip diameter of the probe: 2 μm.

In the support for the planographic printing plate precursor of the invention, it is preferable that its surface has a grain structure wherein a large wave structure having an average wavelength of 5 to 100 μm, a medium wave structure having an average aperture of 0.5 to 5 μm, and a small wave structure having an average aperture of 0.01 to 0.2 μm are superimposed. This wave structure can be detected by observing a section of the support.

In the aluminum support surface according to the invention, the large wave structure having an average wavelength of 5 to 100 μm has an effect for increasing water-holding capacity of non-image portions of the planographic printing plate, that is, the surface of the area where the support surface is naked. As the amount of water held on this surface is larger, the surface of the non-image portions is less easily affected by pollution in the atmosphere. Even if the plate is left as it is in the middle of printing, non-image portions which are not easily stained can be obtained. The average wavelength of the large wave structure is more preferably from 10 to 80 μm.

When the large wave structure is formed, the amount of damping water given to the plate surface at the time of printing can easily be checked with the naked eye. Thus, the examinable property of the planographic printing plate becomes superior. When the average wavelength of the large wave structure is within this range, the excellent water-holding capacity and plate-examinable property can be attained.

The medium wave structure having an average aperture of 0.5 to 5 μm, which is superimposed with the large wave structure, has a function of holding the recording layer mainly by anchor effect to give superior adhesiveness between the support and the image recording layer, thereby improving the printing durability.

The small wave structure having an average aperture of 0.01 to 0.2 μm, which is superimposed with the medium wave structure, has a function of improving the stain resistance chiefly. In the case that damping water is given to the planographic printing plate at the time of printing, the combination of the medium wave structure with the small wave structure makes it possible to form a water film uniformly on the surface so as to suppress the generation of stain on the non-image portions. Furthermore, the effect of improving the printing durability by the medium wave structure is kept and further the stain resistance can be improved when the average aperture of pits in the small wave structure is within the above-mentioned range. As a result, the advantageous effects of both of the medium wave structure and the small wave structure are sufficiently exhibited.

Regarding the small wave structure, not only the aperture of the pits but also the depth of the pits may be controlled. In this case, the stain resistance can be made better. That is, it is preferable to set the ratio of the depth of the small wave structure to the aperture thereof to 0.2 or more. In this way, the water film that is uniformly formed is certainly held on the surface, so that the stain resistance of the non-image portion surface is kept for a long term.

Regarding the support used in the planographic printing plate precursor of the invention, the following describes methods for measuring the average wavelength of the large wave structure of the surface, the average aperture of the medium wave structure, the average aperture of the small wave structure, and the average ratio of the depth thereof to the aperture thereof.

(1) Average Wavelength of the Large Wave Structure

A profilometer is used to carry out two-dimensional roughness measurement of the surface, thereby measuring the average mountain interval Sₘ, described in ISO 4287, of the surface 5 times. The average thereof is defined as the average wavelength.

(2) Average Aperture of the Medium Wave Structure

An electron microscope is used to take a picture of the surface of the support from just above with 2000 magnifications. From the obtained electron microscopic photograph, at least 50 pits of the medium wave structure (medium wave pits), the circumferences of which are stretched in a ring form, are extracted. The diameters thereof are read out. The read values are regarded as the apertures of the medium wave pits. From the apertures, the average aperture thereof is calculated. In the case of the structure wherein the large wave structure is superimposed with the medium wave structure, the average aperture of the medium wave structure is measured by the same method.

In order to suppress a scattering in the measured values, the equivalent circular diameter can also be measured by use of a commercially available image analysis software. In this case, the above-mentioned electron microscopic photograph is taken in a scanner and then binarize by use of the software. Thereafter, the equivalent circular diameter is obtained.

The measurement by the present inventor demonstrated that the results from measurement with the naked eye are substantially equal to those from the digital treatment. This is the same in the case of the structure wherein the medium wave structure is superimposed with the large wave structure.

(3) Average Aperture of the Small Wave Structure

A high-resolution scanning electron microscope (SEM) is used to take a picture of the surface of the support from just above with 50000 magnifications. From the obtained SEM photograph, at least 50 pits of the small wave structure (small wave pits) are extracted. The diameters thereof are read out. The read values are regarded as the apertures of the small wave pits. From the apertures, the average aperture thereof is calculated.

(4) Average Ratio of the Depth of the Small Wave Structure to the Aperture Thereof

A high-resolution scanning electron microscope (SEM) is used to take a picture of a section of the support with 50000 magnifications. From the obtained SEM photograph, at least 20 small wave pits are extracted. The diameters thereof and the corresponding depths thereof are read out. From these values, the ratios therebetween are obtained. From the ratios, the average thereof is calculated.

As described above, the support for the planographic printing plate precursor according to the invention has a central line average roughness Ra of less than 0.70 μm and has, in the surface thereof, a grain structure wherein the wave structures are superimposed. Furthermore, the number of concave portions which are present in this surface and have a depth of 3 μm or more is from 10 to 60 per mm². In this manner, no dotty residual film is generated even if conditions for exposure and development are made strict.

The present inventor made eager investigation on the relationship between the dotty residual film and deep concave portions in the support surface, which cause of the dotty residual film. As a result, it has been found out that the number of concave portions having a depth of 3 μm or more in the surface is related to the generation of the dotty residual film. Thus, the invention has been made.

The method for measuring the number of the concave portions which have a depth of 3 μm or more in the support for the planographic printing plate precursor of the invention is as follows:

A three-dimensional non-contact type surface-shape measuring device is used. The measuring manner thereof may be a laser manner or an optical interference manner.

This three-dimensional non-contact type surface-shape measuring device is used to scan a 400-μm² area of the surface at a pitch of 0.01 μm in a non-contact manner, thereby obtaining three-dimensional data. From the three-dimensional data, the number of the concave portions having a depth of 3 μm or more is counted.

The inventor made eager investigation on causes for generating the concave portions having a depth of 3 μm or more by surface-roughening treatment, which will be detailed later. As a result, the causes were presumed as follows:

Firstly, in the case of applying surface-roughening treatment including mechanical surface-roughening treatment to the surface, edges of grains of an abrasive used in the mechanical surface-roughening treatment stick deeply into the surface of the aluminum plate to make concave portions.

Secondly, in the case of applying surface-roughening treatment including electrolytic surface-roughening treatment, an electric current is concentrated at a specific spot at the time of the electrolytic surface-roughening treatment.

The inventor presumed the causes as described above and further made eager investigation. As a result, it has been found out that the number of concave portions having a depth of 3 μm or more, which are generated by surface-roughening treatment, can be set to 60 per mm² or less by methods described below.

That is, the following methods (i) to (v) have been found out against the first cause, i.e., the matter that grains of an abrasive used in mechanical surface-roughening treatment stick into the surface of the aluminum plate.

(i) An abrasive having a small grain diameter is used.

The grain diameter of the abrasive can be made small, for example, by performing sedimentation to remove grains having a large grain diameter and then using only grains having a small grain diameter, or by bringing grains of the abrasive into contact with each other by re-pulverization to cause the grains to be worn away.

(ii) An abrasive made of grains which are not much sharp-pointed is used.

Pumice stone, which may be referred to as “pumice” hereinafter and is usually used in mechanical surface-roughening treatment, is obtained by pulverizing volcanic ashes. Particles thereof are in the form of a plate like crushed glass, and edges thereof are sharp. On the other hand, silica sand has a shape like a dodecahedron or icositetrahedron, and is not much sharp-pointed.

(iii) Bristles of a brush used in the mechanical surface-roughening treatment are made soft.

The brush bristles can be made soft, for example, by making the diameter of the brush bristles small or making the material for the brush soft.

(iv) The rotation speed of the brush used in the mechanical surface-roughening treatment is made low.

The sticking of the grains is suppressed by giving an appropriate time for “escape” to abrasive grains contained in slurry.

(v) The pressing power (load) of the brush used in the mechanical surface-roughening treatment is made low.

More specific conditions for these methods will be described in detail later.

The following methods (vi) to (viii) have been found out against the second cause, that is, the matter that an electric current is concentrated at a specific spot at the time of electrolytic surface-roughening treatment.

(vi) In the case of using an electrolyte made mainly of nitric acid in the electrolytic surface-roughening treatment, the amount of Cu in alloy components for the aluminum plate is made a low value within a given range in order to cause the electrolysis uniformly with ease.

In the electrolytic surface-roughening treatment, an alternating current is usually sent into an acidic electrolyte, thereby causing dissolution reaction of the aluminum (pitting reaction) and smut adhering reaction, wherein components generated by the dissolution adhere again onto the dissolution reaction portions, alternately in accordance with cycles of the alternating current. In the case of using the electrolyte of nitric acid, the treatment is very easily affected by the kind and amount of alloy components contained in the Al plate, in particular, Cu. It appears that this is because the resistance of the surface at the time of the electrolytic surface-roughening treatment is made high by the presence of Cu. Therefore, the amount of Cu in the alloy components is set to a target value of 0.05% or less by mass, whereby the surface resistance at the electrolytic surface-roughening treatment can be controlled. As a result, electric current concentration is suppressed so that uniform pits having a size of 0.5 to 5 μm can be made in the entire surface without forming any coarse pit.

(vii) In the case of using an electrolyte made mainly of nitric acid in the electrolytic surface-roughening treatment, pre-electrolysis is performed before the electrolytic surface-roughening treatment.

According to the pre-electrolysis, starting points for forming pits can be uniformly formed. In this way, uniform pits can be made in the entire surface without forming any coarse pit in the electrolytic surface-roughening treatment, which is afterwards performed.

By the above-mentioned methods, the number of the concave portions, which are present in the surface and have a depth of 3 μm or more, can be set to 60 per mm². The lower limit of the number of the concave portions is not limited. The number is preferably 10 per mm² or more from the viewpoint of stain resistance. It appears that this is because at the time of printing, in particular, at the time when the plate surface gets dry in the middle of printing (for example, at the time when printing is temporarily stopped), the damping water held by deep concave portions in non-image portions of the planographic printing plate suppresses any adhesion of stains to the plate surface. Accordingly, in the support for the planographic printing plate precursor of the invention, the number of the concave portions, which are present in the surface and have a depth of 3 μm or more, is preferably from 10 to 60 per mm² in order to make the stain resistance good and generate no dotty residual film even if conditions for exposure and development are made strict.

As described above, in the support for the planographic printing plate precursor of the invention, the central line average roughness Ra thereof is set to less than 0.60 μm, the grain structure of the surface thereof is made to a structure wherein a large wave structure having an average wavelength of 5 to 100 μm, a medium wave structure having an average aperture of 0.5 to 5 μm, and a small wave structure having an average aperture of 0.01 to 0.2 μm are superimposed, and further the number of concave portions which are present in the surface and have a depth of 3 μm or more is from 10 to 60 per mm² in order that no dotty residual film will be generated and excellent stain resistance and printing durability will be exhibited when the support is used to form the planographic printing plate.

<Surface Treatment>

The support for the planographic printing plate precursor of the invention is a support wherein surface treatment is applied to an aluminum plate, which will be detailed later, thereby forming the above-mentioned grain structure in a surface of the aluminum plate. This support can be obtained by applying surface-roughening treatment and anodic oxidation treatment to an aluminum plate. The process for producing this support is not particularly limited, and may include various steps other than the surface-roughening treatment and the anodic oxidation treatment.

Typical examples of the method for forming the above-mentioned grain structure in the surface include a method of applying, to an aluminum plate, mechanical surface-roughening treatment, alkali etching treatment, desmutting treatment with an acid, and electrochemical surface-roughening treatment with an electrolyte in sequence; a method of applying, to an aluminum plate, mechanical surface-roughening treatment, alkali etching treatment, desmutting treatment with an acid, and repeated operations of electrochemical surface-roughening treatment, in which different electrolytes are used; a method of applying, to an aluminum plate, alkali etching treatment, desmutting treatment with an acid, and electrochemical surface-roughening treatment with an electrolyte in sequence; and a method of applying, to an aluminum plate, alkali etching treatment, desmutting treatment with an acid, and repeated operations of electrochemical surface-roughening treatment, in which different electrolytes are used. In the invention, however, the method for forming the grain structure is not limited to these methods. In these methods, alkali etching treatment and desmutting treatment with an acid may be further conducted after the electrochemical surface-roughening treatments.

In the support for the planographic printing plate precursor of the invention, obtained by any one of these methods, a structure wherein irregularities having three or more different periods are superimposed is formed in the surface. Thus, when the support is used to form the planographic printing plate, this plate has both of excellent stain resistance and printing durability.

The following describes the respective steps of the surface treatment in detail.

<Mechanical Surface-Roughening Treatment>

Mechanical surface-roughening treatment is effective as a method for surface-roughening treatment since this treatment makes it possible to form a surface having irregularities having an average wavelength of 5 to 100 μm more easily than electrochemical surface-roughening treatment.

Examples of the mechanical surface-roughening treatment which can be used include a wire brush graining method, wherein the surface of aluminum is scratched with a metal wire; a ball graining method, wherein the surface of aluminum is grained with abrading balls and an abrading agent; a brush graining method wherein the surface is grained with a nylon brush and an abrading agent, described in JP-A No. 6-135175 and JP-B No. 50-40047.

Other examples thereof include transfer methods, wherein an uneven surface is pressed against an aluminum plate, specific examples thereof including methods described in JP-A Nos. 55-74898, 60-36195 and 60-203496, and a method characterized by performing transfer several times, described in JP-A No. 6-55871, and a method characterized in that the surface is elastic, described in Japanese Patent Application No.4-204235 (JP-A No. 6-24168).

Additional examples thereof include a method of using a transferring roll wherein fine irregularities are etched by electric discharge machining, shot blast, air blast, laser, plasma etching or the like to perform transfer repeatedly; and a method of bringing an uneven surface, onto which fine particles are applied, into contact with an aluminum plate, and applying pressure onto the resultant product plural times, thereby transferring an uneven pattern corresponding to the average diameter of the fine particles onto the aluminum plate plural times. The method for giving fine irregularities onto a transferring roll may be any known method, described in JP-A No. 3-8635, 3-66404, 63-65017 or the like. Rectangular irregularities may be made in a transferring roll by cutting fine grooves in the surface in two directions by use of a dice, bite, laser or the like. This roll surface may be subjected to a treatment for making the formed rectangular irregularities round by known etching treatment.

In order to make the hardness of the surface high, the surface may be subjected to quenching, hard chromium plating or the like.

Besides, methods described in JP-A Nos. 61-162351, 63-104889 and so on can be used as the mechanical surface-roughening treatment.

In the invention, the above-mentioned methods may be used in combination, considering the productivity thereof and so on. These mechanical surface-roughening treatments are preferably conducted before electrochemical surface-roughening treatment.

The following describes the brush graining method, which is used suitably for the mechanical surface-roughening treatment.

In general, the brush graining method can be performed by spraying a slurry containing an abrasive onto a rotating roller-form brush wherein a great number of brush bristles, such as synthetic resin bristles made of a synthetic resin (for example, Nylon (trade name), propylene resin, or vinyl chloride resin), are planted in the surface of a cylindrical trunk while scrubbing one or both of surfaces of the above-mentioned aluminum plate with the roller. Instead of the roller-form brush or the slurry, an abrading roller, which has on the surface thereof an abrading layer, may be used.

In the case of using the roller-form brush, the bend elastic constant thereof is preferably from 10,000 to 40,000 kg/cm², more preferably from 15,000 to 35,000 kg/cm² and the firmness of the brush bristles is preferably 500 g or less, more preferably 400 g or less. The diameter of the brush bristles is generally from 0.2 to 0.9 mm. The length of the bristles, which may be appropriately decided in accordance with the outer diameter of the brush and that of the trunk, is generally from 10 to 100 mm.

The diameter of the brush bristles is preferably 0.5 mm or less in order to prevent the formation of a large number of deep concave portions.

The surface-roughening treatment includes plural treatments. Therefore, in each of the treatments, conditions for adjusting the central line average roughness Ra of the support surface after the surface-roughening treatment into a specific range cannot be decided without reservation. However, it has been found out that in the mechanical surface-roughening treatment, the selection of conditions about the roller-form brush, for example, the density of bristles thereof (hereinafter referred to as the “brush bristle density”) and the rotation speed thereof, is effective for the adjustment of the central line average roughness Ra of the support surface after the surface-roughening treatment.

To make the brush bristle density and the rotation speed low in the invention is effective for the adjustment of the central line average roughness Ra into the specific range.

Specifically, the brush bristle density is preferably 600 per cm² or less, more preferably 500 per cm² or less, and even more preferably 450 per cm² or less in the invention.

The rotation speed of the roller-form brush is preferably 300 rpm or less.

The abrasive may be a known abrasive. Examples thereof include pumice stone, silica sand, aluminum hydroxide, alumina powder, silicon carbide, silicon nitride, volcanic ashes, carborundum, emery, and mixtures thereof. Of these examples, pumice stone and silica sand are preferable. Silica sand is particularly preferable since silica sand is harder and less brittle than pumice stone to have better surface-roughening efficiency and silica sand can prevent the formation of a great number of deep concave portions.

The average grain diameter of the abrasive is preferably from 3 to 50 μm, more preferably from 6 to 45 μm in order that the surface-roughening efficiency can be made better and the pitch of the grains can be made smaller. About pumice stone and silica sand, the median diameters are preferably 30 μm or less and 20 μm or less, respectively, in order to prevent the formation of a great number of deep concave portions.

The abrasive is suspended in, for example, water and used as a slurry. The slurry may contain a thickener, a dispersing agent (such as a surfactant), a preservative or the like besides the abrasive. The specific gravity of the slurry is preferably from 0.5 to 2.

A machine suitable for the mechanical surface-roughening treatment is, for example, a machine described in JP-B No. 50-40047.

<Electrochemical Surface-Roughening Treatment>

For the electrochemical surface-roughening treatment, electrolytes used in electrochemical surface-roughening treatments using an ordinary alternating current are used. Of the electrolytes, an electrolyte made mainly of hydrochloric acid and nitric acid is used to make it possible to form an irregularity structure characteristic for the invention.

It is preferable to conduct, as the electrochemical surface-roughening treatment in the invention, first and second electrolyzing treatments using an alternating current in an acidic solution before and after cathode electrolyzing treatment. By the cathode electrolyzing treatment, hydrogen gas is generated in the surface of the aluminum plate to generate smut, thereby making the surface state uniform. Thereafter, therefore, uniform electrolytic surface-roughening can be attained at the time of the electrolyzing treatment using the alternating current.

This electrolytic surface-roughening treatment can be performed in accordance with the electrochemical graining method (electrolytic graining method) described in JP-B No. 48-28123 and GB Patent No. 896,563. In this electrolytic graining method, an alternating current having a sine waveform is used. An especial waveform as described in JP-A No. 52-58602 may be used. A waveform described in JP-A No. 3-79799 may be used. Methods described in the following can be used: JP-A Nos. 55-158298, 56-28898, 52-58602, 52-152302, 54-85802, 60-190392, 58-120531, 63-176187, 1-5889, 1-280590, 1-118489, 1-148592, 1-178496, 1-188315, 1-154797, 2-235794, 3-260100, 3-253600, 4-72079, 4-72098, 3-267400 and 1-141094. Besides the above, the electrolysis may be performed using an alternating current having an especial frequency, suggested as a process for producing an electrolytic condenser. This is described in, for example, U.S. Pat. Nos. 4,276,129 and 4,676,879.

Electrolytic baths and power sources that can be used are variously suggested, examples of which include those described in U.S. Pat. No. 4,203,637, and JP-A Nos. 56-123400, 57-59770, 53-12738, 53-32821, 53-32822, 53-32823, 55-122896, 55-132884, 62-127500, 1-52100, 1-52098, 60-67700, 1-230800, 3-257199, 52-58602, 52-152302, 53-12738, 53-12739, 53-32821, 53-32822, 53-32833, 53-32824, 53-32825, 54-85802, 55-122896, 55-132884, 52-133838, 52-133840, 52-133844, 52-133845, 53-149135 and 54-146234, and JP-B Nos. 48-28123 and 51-7081.

Examples of the acidic solution as an electrolyte include nitric acid, hydrochloric acid, and electrolytes described in U.S. Pat. Nos. 4,671,859, 4,661,219, 4,618,405, 4,600,482, 4,566,960, 4,566,958, 4,566,959, 4,416,972, 4,374,710, 4,336,113, and 4,184,932.

The concentration of the acidic solution is preferably from 0.5 to 2.5% by mass, and is particularly preferably from 0.7 to 2.0% by mass considering the use thereof in the treatment for removing the above-mentioned smut. The temperature of the solution is preferably from 20 to 80° C., more preferably from 30 to 60° C.

The aqueous solution made mainly of hydrochloric acid or nitric acid can be used in the state of adding, to an aqueous hydrochloric acid or nitric acid solution having a concentration of 1 to 100 g/L, at least one of nitric acid compound having a nitric acid ion (such as aluminum nitride, sodium nitride, or ammonium nitride) and hydrochloric acid compound having an hydrochloric acid ion (such as aluminum chloride, sodium chloride or ammonium chloride) at a concentration ranging from 1 g/L to the saturated concentration thereof. Into the aqueous solution made mainly of hydrochloric acid or nitric acid, a metal contained in aluminum alloy may be dissolved, examples of which include iron, copper, manganese, nickel, titanium, magnesium, or silica. It is preferable to use a solution wherein aluminum chloride, aluminum nitrate or the like is added to an aqueous hydrochloric acid or nitric acid solution having a concentration of 0.5 to 2% by mass so as to set the concentration of aluminum ions into the range of 3 to 50 g/L.

The wording “aqueous solution made mainly of a certain component” means that the component is contained in the aqueous solution in an amount of 30% (preferably 50%) by mass of all constituents added to the aqueous solution. The same matter is correspondingly applied to the following.

An aluminum plate containing a great quantity of Cu can be uniformly grained by adding a compound which can be combined with Cu to form a complex to the electrolyte and using the resultant. Examples of the compound, which can be combined with Cu to form a complex, include ammonia; amines wherein the hydrogen atom(s) is/are substituted with one or more hydrocarbon groups (such as aliphatic and aromatic hydrocarbon groups), such as methylamine, ethylamine, dimethylamine, diethylamine, trimethylamine, cyclohexylamine, triethanolamine, triisopropanolamine, and EDTA (ethylenediaminetetracetic acid); and metal carbonates such as sodium carbonate, potassium carbonate, and potassium hydrogencarbonate; ammonium salts such as ammonium nitrate, ammonium chloride, ammonium sulfate, ammonium phosphate, and ammonium carbonate.

The temperature thereof is preferably from 10 to 60° C., more preferably from 20 to 50° C.

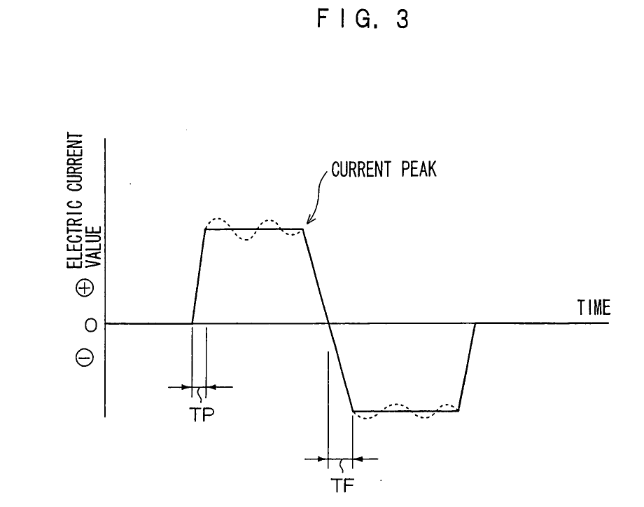

The alternating current wave used in the electrochemical surface-roughening treatment is not particularly limited, and may be a sine wave, a rectangular wave, a trapezoidal wave, a triangular waver, or some other wave. A rectangular wave and a trapezoidal wave are preferable, and the latter is particularly preferable. The trapezoidal wave is a wave illustrated in FIG. 3. In this trapezoidal wave, the time (TP) when electric current rises from zero to a peak is preferably from 0.2 to 3 msec. If the TP is less than 0.2 msec, a treatment-unevenness called a chatter mark and generated perpendicularly in the direction along which the aluminum plate is advanced is easily generated. If the TP is more than 3 msec, the following problem is caused, in particular, in the case of using the nitric acid electrolyte: trace components (typically, ammonium ions) which increase naturally in the electrolyte in the electrolysis produce a bad effect. Thus, uniform graining is not easily performed. As a result, when the plate is used to form a planographic printing plate, the stain resistance thereof tends to lower.

The duty ratio of the trapezoidal wave may be from 1:2 to 2:1. The duty ratio is preferably 1:1 in an indirect power feeding manner without using any conductor roller for aluminum, as described in JP-A No. 5-195300.

The frequency of the trapezoidal wave may be from 0.1 to 120 Hz, and is preferably from 50 to 70 Hz from the viewpoint of facilities. If the frequency is less than 50 Hz, a carbon electrode as a main electrode is easily dissolved. If the frequency is more than 70 Hz, inductance components on a power supply circuit easily produce a bad effect to make power supply costs high.

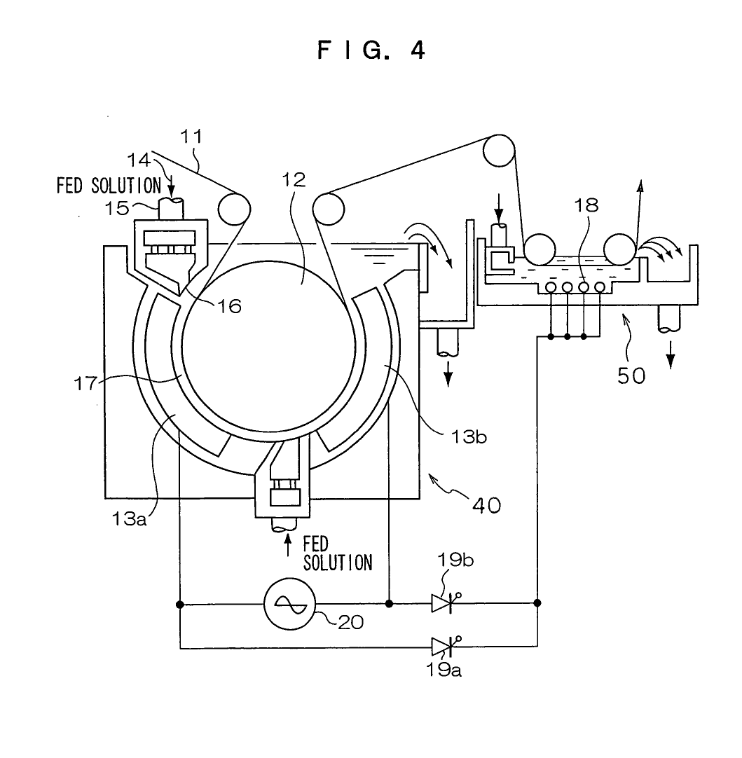

One or more AC power supplies can be connected to the electrolytic bath. In order to control the current ratio between anode and cathode components of the alternating current applied to the aluminum plate, which is opposite to a main electrode, thereby attaining uniform graining and further dissolve carbon of the main electrode, it is preferable to set an auxiliary anode and cause a part of the alternating current to flow dividedly into the auxiliary anode, as illustrated in FIG. 4. In FIG. 4, reference number 11 represents an aluminum plate; 12, a radial drum roller; 13a and 13b, main electrodes; 14, an electrolyte; 15, an electrolyte supplying port; 16, a slit; 17, an electrolyte passage; 18, an auxiliary electrode; 19a and 19b, thyristors; 20, an AC power supply; 40, a main electrolytic bath; and 50, an auxiliary cathode bath. By dividing electric current to cause a part thereof to flow, through a rectifying element or switching element, as a direct current into the auxiliary electrode, which is set into a bath different from the bath for the two main electrodes, it is possible to control the ratio between the current value for taking charge of anodic reaction caused on the aluminum plate opposite to the main electrodes and the current value for taking charge of cathodic reaction. On the aluminum plate opposite to the main electrodes, the ratio of the electricity quantity for the cathodic reaction to that for the anodic reaction (i.e., the ratio of the electricity quantity in the cathodic reaction time to that in the anodic reaction time) is preferably from 0.3 to 0.95.

The electrolytic bath may be a known electrolytic bath used in surface treatment, for example, a bath of a lengthwise type, a flat type, a radial type, or some other type. A radial type electrolytic bath, as described in JP-A No. 5-195300, is particularly preferable. The electrolyte passed in the electrolytic bath may be in parallel to or opposite to the direction in which the aluminum plate is advanced.

(Nitric Electrolysis)

By the electrochemical surface-roughening treatment using an electrolyte made mainly of nitric acid, pits having an average aperture of 0.5 to 5 μm can be made. However, when the electricity quantity is made relatively large, electrolytic reaction is caused so as to be concentrated so that honeycomb pits having an aperture of more than 5 μm also can be made.

In order to obtain such a grain structure, the total of electricity quantities for taking charge of the anodic reaction of the aluminum plate is preferably from 1 to 1000 C/dm², more preferably from 50 to 300 C/dm² when the electrolytic reaction ends. The current density at this time is preferably from 20 to 100 A/dm².

When a nitric acid electrolyte having a high concentration and/or a high temperature is used, a small wave structure having an average aperture of 0.2 μm or less can also be formed.

By performing a second alkali etching treatment, a desmutting treatment and further a second electrolytic surface-roughening treatment after the electrolytic surface-roughening treatment using a nitric acid electrolyte, inside the pits having the average aperture of 0.5 to 25 μm a small wave structure, which has a shorter pitch wavelength and an average aperture of 0.01 to 0.2 μm, is easily generated. Specifically, by performing hydrochloric acid electrolysis described below, a small wave structure having an aperture of 0.01 to 0.2 μm can be produced.

(Second Electrolysis)

In the second electrolysis, hydrochloric acid, which has a high corrosiveness, is used to perform electrolysis slightly, whereby pits having an average aperture of 0.01 to 0.2 μm can be uniformly made in the surface. In the second hydrochloric acid electrolysis, the concentration of hydrochloric acid is preferably from 1 to 15 g/L, and the electricity quantity in the anodic reaction time is preferably from 1 to 100 C/dm², more preferably from 20 to 70 C/dm². The current density at this time is preferably from 20 to 50 A/dm². In order to remove smut after the second electrolysis, it is preferable to perform alkali etching. The dissolved-aluminum amount in the alkali etching is preferably from 0.03 to 0.6 g/m².

In this electrochemical surface-roughening treatment using the electrolyte made mainly of hydrochloric acid, large undulations in a crater form can be simultaneously formed by making the total of electricity quantities for taking charge of the anodic reaction as large as a value ranging 400 to 1000 C/dm². In this case, fine irregularities having an average aperture of 10 to 30 μm are superimposed with the crater undulations, which have an average aperture of 10 to 30 μm, and the fine irregularities are made in the entire surface. In this case, therefore, no medium wave structure, which has an average aperture of 0.5 to 5 μm, can be superimposed with the above-mentioned undulations and irregularities. Thus, the surface grain structure which is characteristic for the invention cannot be produced.

<Alkali Etching>

The alkali etching treatment is treatment for bringing the aluminum plate into contact with an alkali solution to dissolve the surface layer thereof.

In the case of conducting no mechanical surface-roughening treatment, the alkali etching treatment conducted before the electrochemical surface-roughening treatment is for removing rolling oil, stains, naturally-oxidized film and others on the surface of the aluminum plate (e.g., rolled aluminum). In the case of conducting the mechanical surface-roughening treatment already, this treatment is for dissolving edges of irregularities generated by the mechanical surface-roughening treatment to convert the sharp irregularities to the surface having gently-sloping undulations.

In the case of conducting no mechanical surface-roughening treatment before the alkali etching treatment, the etching amount is preferably from 0.1 to 10 g/m², more preferably from 1 to 5 g/m². If the etching amount is less than 0.1 g/m², the rolling oil, stains and naturally-oxidized film on the surface may remain. As a result, uniform pits are not generated in a subsequent electrochemical surface-roughening treatment, so that unevenness may be generated. On the other hand, when the etching amount is from 1 to 10 g/m², the rolling oil, stains and naturally-oxidized film on the surface are sufficiently removed. If the etching amount is more than the upper limit of the above-mentioned range, an economical disadvantage is encountered.

In the case of conducting the mechanical surface-roughening treatment before the alkali etching treatment, the etching amount is preferably from 1 to 20 g/m², more preferably from 3 to 15 g/m². If the etching amount is less than 1 g/m², the irregularities made by the mechanical surface-roughening treatment and so on may not be made smooth. Thus, in the subsequent electrochemical treatment, uniform pits may not be formed. Additionally, staining may increase at the time of printing. On the other hand, if the etching amount is more than 20 g/m², the irregularities may disappear and further an economical disadvantage is encountered.

The alkali etching treatment just after the electrochemical surface-roughening treatment is conducted to dissolve the smut generated in the acidic electrolyte and dissolve edges of pits made by the electrochemical surface-roughening treatment.

The pits made by the electrochemical surface-roughening treatment vary dependently on the kind of the electrolyte. Thus, the optimal etching amount thereof is also different. The etching amount in the alkali etching treatment conducted after the electrochemical surface-roughening treatment is preferably from 0.1 to 5 g/m². In the case of using the nitric acid electrolyte, it is necessary to set the etching amount larger than in the case of using the hydrochloric acid electrolyte.

Examples of the alkali used in the alkali solution include caustic alkalis and alkali metal salts. Specific examples of the caustic alkalis include caustic soda and caustic potassium. Specific examples of the alkali metal salts include alkali metal silicates such as sodium metasilicate, sodium silicate, potassium metasilicate, and potassium silicate; metal carbonates such as sodium carbonate and potassium carbonate; alkali metal aluminates such as sodium aluminate and potassium aluminate; alkali metal aldonates such as sodium gluconate and potassium gluconate; and alkali metal (hydrogen)phosphates such as disodium hydrogenphosphate, dipotassium hydrogenphosphate, trisodium phosphate, and tripotassium phosphate. A solution of a caustic alkali and a solution containing both of a caustic alkali and an alkali metal aluminate are preferable since the solutions give a high etching rate and are inexpensive. An aqueous caustic soda solution is particularly preferable.

The alkali concentration of the alkali solution, which can be decided dependently on the etching amount, is preferably from 1 to 50% by mass, more preferably from 3 to 35% by mass. In the case that aluminum ions are dissolved in the alkali solution, the concentration of the aluminum ions is preferably from 0.01 to 10% by mass, more preferably from 3 to 8% by mass. The temperature of the alkali solution is preferably from 20 to 90° C. The time for the treatment is preferably from 1 to 120 seconds.

Examples of the method for bringing the aluminum plate into contact with the alkali solution include a method of passing the aluminum plate through a bath in which the alkali solution is put, a method of immersing the aluminum plate into a bath in which the alkali solution is put, and a method of spraying the alkali solution onto the surface of the aluminum plate.

<Desmutting Treatment>

After the electrochemical surface-roughening treatment and the alkali etching treatment, washing with an acid (desmutting treatment) is conducted to remove the smut remaining on the surface. Examples of the used acid include nitric acid, sulfuric acid, phosphoric acid, chromic acid, hydrofluoric acid, and fluoroboric acid.

The desmutting treatment is conducted, for example, by bringing the aluminum plate into contact with an acidic solution which has an acid concentration of 0.05 to 30% by mass, the acid being hydrochloric acid, nitric acid, sulfuric acid or the like, (and may contain 0.01 to 5% by mass of aluminum ions). Examples of the method for bringing the aluminum plate into contact with the acidic solution include a method of passing the aluminum plate through a bath in which the acidic solution is put, a method of immersing the aluminum plate into a bath in which the acidic solution is put, and a method of spraying the acidic solution onto the surface of the aluminum plate.

In the desmutting treatment, it is permissible to use, as the acidic solution, waste of the aqueous solution made mainly of nitric acid or the aqueous solution made mainly of hydrochloric acid discharged in the electrochemical surface-roughening treatment, or to use wastes of an aqueous solution made mainly of sulfuric acid discharged in acidic oxidation treatment, which will be detailed later.

The liquid temperature in the desmutting treatment is preferably from 25 to 90° C. The time for the treatment is preferably from 1 to 180 seconds. Aluminum and aluminum alloy may be dissolved in the acidic solution used in the desmutting treatment.

<Anodic Oxidation Treatment>

The aluminum plate treated as described above is further subjected to anodic oxidation treatment. The anodic oxidation treatment may be conducted by a method which is conventionally performed in this field. In this case, an anodic oxidation film can be formed, for example, by using the aluminum plate as an anode to pass electric current into a solution having a sulfuric acid concentration of 50 to 300 g/L and an aluminum concentration of 5% or less by mass. Examples of the solution used in the anodic oxidation treatment include sulfuric acid, phosphoric acid, chromic acid, oxalic acid, sulfamic acid, benzenesulfonic acid and amidesulfonic acid solutions. These may be used alone or in combination of two or more thereof.

At this time, the electrolyte may contain components which are usually contained in the aluminum plate, the electrodes, tap water, groundwater, and so on. A second component and a third component may be incorporated into the electrolyte. Examples of the second and third components include metal ions, such as Na, K, Mg, Li, Ca, Ti, Al, V, Cr, Mn, Fe, Co, Ni, Cu and Zn ions; cations such as an ammonium ion; and anions such as nitrate, carbonate, chloride, phosphate, fluoride, sulfite, titanate, silicate, and borate ions. The second and third components may be contained at a concentration of about 0 to 10000 ppm.

Conditions for the anodic oxidation treatment cannot be decided without reservation since the conditions vary dependently on the kind of the used electrolyte. In general, however, the following are suitable: electrolyte concentration: 1 to 80% by mass; liquid temperature: 5 to 70° C.; current density: 0.5 to 60 A/dm²; voltage: 1 to 100 V; and electrolyzing time: 15 seconds to 50 minutes. The conditions are adjusted to set the amount of the anodic oxidation film to a desired value.

Methods described in the following can also be used: JP-A Nos. 54-81133, 57-47894, 57-51289, 57-51290, 57-54300, 57-136596, 58-107498, 60-200256, 62-136596, 63-176494, 4-176897, 4-280997, 6-207299, 5-24377, 5-32083, 5-125597, and 5-195291.

As described in JP-A Nos. 54-12853 and 48-45303, it is particularly preferable to use a sulfuric acid solution as the electrolyte. The sulfuric acid concentration in the electrolyte is preferably from 10 to 300 g/L (1 to 30% by mass). The aluminum ion concentration therein is preferably from 1 to 25 g/L (0.1 to 2.5% by mass), more preferably from 2 to 10 g/L (0.2 to 1% by mass). Such an electrolyte can be prepared, for example, by adding aluminum sulfate or the like to dilute sulfuric acid having a sulfuric acid concentration of 50 to 200 g/L.

In the case that the anodic oxidation treatment is conducted in the electrolyte containing sulfuric acid, direct current or alternating current may be applied between the aluminum plate and the counter electrode.

In the case of applying direct current to the aluminum plate, the current density is preferably from 1 to 60 A/dm², more preferably from 5 to 40 A/dm².

In the case of conducting the anodic oxidation treatment continuously, it is preferable to send electric current at a low current density of 5 to 10 A/m² at the initial stage of this treatment and increase the current density up to a value of 30 to 50 A/dm², or more as the treatment advances, in order not to generate “burned”, which is caused by the concentration of the current into a part of the aluminum plate.

In the case of conducting the anodic oxidation treatment continuously, it is preferable to use a liquid power-feeding manner, wherein electric power is fed to the aluminum plate through the electrolyte.

The anodic oxidation treatment under such conditions gives a porous coating having a great number of pores (micropores). Usually, the average pore diameter thereof is from about 5 to 50 nm, and the average pore density is from about 300 to 800 per μm².

The amount of the anodic oxidation film is preferably from 1 to 5 g/m². If the amount is less than 1 g/m², the plate precursor is easily injured. If the amount is more than 5 g/m², a great deal of electric power is necessary for the production of the plate precursor. Thus, an economical disadvantage is encountered. The amount of the anodic oxidation film is more preferably from 1.5 to 4 g/m². It is also preferable to set the difference in the anodic oxidation film amount between the center of the aluminum plate and the vicinity of the edge thereof to 1 g/m² or less.

An electrolyzing device used in the anodic oxidation treatment may be a device described in JP-A No. 48-26638 or 47-18739, JP-B No. 58-24517, or the like.

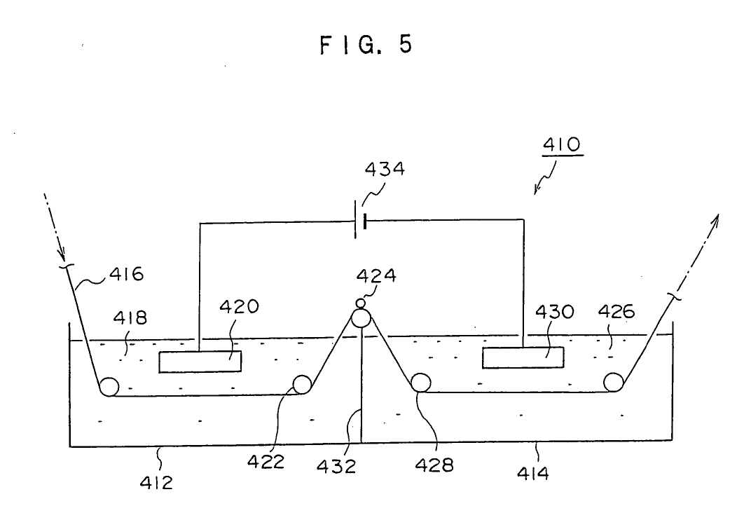

A device illustrated in FIG. 5 is preferably used. FIG. 5 is a schematic view illustrating an example of a device for applying anodic oxidation treatment to the surface of the aluminum plate. In an anodic oxidation treatment device 410, an aluminum plate 416 is carried as shown by an arrow in FIG. 5. The aluminum plate 416 is positively charged by a power feeding electrode 420 in a power feeding bath 412 in which an electrolyte 418 is stored. The aluminum plate 416 is carried upwards by a roller 422 in the power feeding bath 412, and then the direction along which the plate 416 is carried is converted downwards by a nip roller 424. Thereafter, the plate 426 is carried toward an electrolyzing treatment bath 414 in which an electrolyte 426 is stored, and then the direction along which plate 416 is carried is converted into a horizontal direction by a roller 428. Next, the aluminum plate 416 is negatively charged by an electrolyzing electrode 430, thereby forming an anodic oxidation film on the surface thereof. The aluminum plate 416 fed out from the electrolyzing treatment bath 414 is carried into a subsequent step. In the anodic oxidation treatment device 410, the roller 422, the nip roller 424 and the roller 428 constitute a direction converting means. The rollers 422, 424 and 428 carry the aluminum plate 416 into a mountain form or a reverse U-shaped form in an inter-bath section between the power feeding bath 412 and the electrolyzing treatment bath 414. The power feeding electrode 420 and the electrolyzing electrode 430 are connected to a direct current power supply 434.

A characteristic of the anodic oxidation treatment device 410 illustrated in FIG. 5 is that the power feeding bath 412 and the electrolyzing treatment bath 414 are partitioned with one bath wall 432 and the aluminum plate 416 is carried into the mountain or reverse U-shaped form in the inter-bath section. In this way, the length of the aluminum plate 416 in the inter-bath section can be made shortest. Thus, the entire length of the anodic oxidation treatment device 410 can be made short; accordingly, costs for facilities can be decreased. By carrying the aluminum plate 416 into the mountain or reverse U-shaped form, it becomes unnecessary to make an opening through which the aluminum plate 416 can be passed in the bath wall of each of the baths 412 and 414. Thus, it is possible to suppress the liquid-supply amount necessary for keeping the liquid height of each of the baths 412 and 414 at a required level; therefore, running costs can be reduced.

<Pore-Sealing Treatment>

In the invention, pore-sealing treatment for sealing the micropores present in the anodic oxidation film may be conducted if necessary. The pore-sealing treatment can be conducted in accordance with a known treatment method, such as a boiling water treatment, hot water treatment, vapor treatment, sodium silicate treatment, nitrite treatment, or ammonium acetate treatment method. The pore-sealing treatment may be conducted using, for example, a, device and a method described in JP-B No. 56-12518, or JP-A No. 4-4194, 5-202496 or 5-179482.

<Treatment for Obtaining Hydrophilicity>

After the anodic oxidation treatment or after the pore-sealing treatment, treatment for obtaining hydrophilicity may be conducted. Examples of the treatment for obtaining hydrophilicity include treatment with potassium fluorozirnonate described in U.S. Pat. No. 2,946,638, treatment with phosphomolybdate described in U.S. Pat. No. 3,201,247, treatment with alkyl titanate described in GB Patent No. 1,108,559, treatment with polyacrylic acid described in DE Patent No. 1,091,433, treatment with polyvinyl phosphate described in DE Patent No. 1,134,093 and GB Patent No. 1,230,447, treatment with phosphonic acid described in JP-B No. 44-6409, treatment with phytic acid described in U.S. Pat. No. 3,307,951, treatment with a bivalent metal salt of a lipophilic organic polymer compound described in JP-A Nos. 58-16893 and 58-18291, treatment of forming an undercoat layer made of a hydrophilic cellulose (such as carboxymethylcellulose) containing a water-soluble metal salt (such as zinc acetate) described in U.S. Pat. No. 3,860,426, and treatment of forming an undercoat layer made of a water-soluble polymer having a sulfo group, described in JP-A No. 59-101651.

Other examples thereof include undercoating treatments with a phosphate described in JP-A No. 62-019494, a water-soluble epoxy compound described in JP-A No. 62-033692, phosphoric acid modified starch described in 62-097892, a diamine compound described in JP-A No. 63-056498, an inorganic acid salt or organic acid salt of an amino acid described in 63-130391, an organic phosphonic acid having a carboxyl group or hydroxyl group described in 63-145092, a compound having an amino group and a phosphonic acid group described in JP-A No. 63-165183, a specific carboxylic acid derivative described in JP-A No. 2-316290, a phosphoric acid ester (phosphate) described in JP-A No. 3-215095, a compound having an amino group and a phosphorus oxyacid group described in JP-A No.3-261592, a phosphate described in JP-A No. 3-215095, an aliphatic or aromatic phosphonic acid, such as phenylphosphonic acid, described in JP-A No. 5-246171, a compound which contains a sulfur atom, such as thiosalicylic acid, described in JP-A No. 1-307745, and a compound having a phosphorus oxyacid group described in JP-A No. 4-282637.

Coloring may be performed using an acidic dye described in JP-A No. 60-64352.

The treatment for obtaining hydrophilicity is preferably conducted by a method of immersing the support into an aqueous solution of an alkali metal silicate such as sodium silicate or potassium silicate, a method of applying a hydrophilic vinyl polymer or a hydrophilic compound onto the support to form a hydrophilic undercoat layer, or some other method.

The treatment for obtaining hydrophilicity by use of the aqueous solution of alkali metal silicate such as sodium silicate or potassium silicate can be conducted by methods and steps described in U.S. Pat. Nos. 2,714,066 and 3,181,461.

Examples of the alkali metal silicate include sodium silicate, potassium silicate and lithium silicate. The aqueous solution of alkali metal silicate may contain an appropriate amount of sodium hydroxide, potassium hydroxide, lithium hydroxide, or the like.

The aqueous solution of alkali metal silicate may contain an alkaline earth metal salt or a IV (IVA) group metal salt. Examples of the alkaline earth metal salt include nitrates such as calcium nitrate, strontium nitrate, magnesium nitrate and barium nitrate; sulfates; chlorides; phosphates; acetates; oxalates; and borates. Examples of the IV (IVA) group metal salt include titanium tetrachloride, titanium trichloride, titanium potassium fluoride, titanium potassium oxalate, titanium sulfate, titanium tetraiodide, zirconium chlorooxide, zirconium dioxide, zirconium oxychloride, and zirconium tetrachloride. These alkaline earth metal salts and the IV (IVA) group metal salts may be used alone or in combination of two or more thereof.

The amount of Si absorbed by the alkali metal silicate treatment can be measured with a fluorescent X-ray analyzer, and the amount is preferably from about 1.0 to 15.0 mg/m².

This alkali metal silicate treatment makes it possible to produce an effect of improving the dissolution resistance of the surface of the support for the planographic printing plate precursor against alkali developer and suppress the elution of aluminum components into the developer to decrease the generation of development scum resulting from the fatigue of the developer.

The treatment for obtaining hydrophilicity by the formation of a hydrophilic undercoat layer can also be conducted under conditions and steps described in JP-A Nos. 59-101651 and 60-149491.

Examples of the hydrophilic vinyl polymer used in this method include polyvinyl sulfonic acid; and copolymers made from a sulfo-group-containing vinyl polymerizable compound (such as p-styrenesulfonic acid), which has a sulfo group, and an ordinary vinyl polymerizable compound (such as alkyl (metha)acrylate). Examples of the hydrophilic compound used in this method include compounds having at least one selected from the group consisting of —NH₂—, —COOH and sulfo groups.

<Water Washing Treatment>

Water washing is preferably conducted after the end of each of the above-mentioned treatments. For the water washing, pure water, well water, tap water or the like can be used. In order to prevent the solution for each of the treatments from being brought into the next step, a nip device may be used.

<Aluminum Plate (Rolled Aluminum)>

A known aluminum plate can be used to obtain a support suitable for the planographic printing plate precursor of the invention. The aluminum plate that can be used in the invention is a plate made of a metal made mainly of aluminum, which is stable in size, and is made of aluminum or aluminum alloy. An alloy plate containing aluminum, as the main component thereof, and trace amounts of alien elements can be used as well as a pure aluminum plate. By setting the amount of Cu to a given value of 0.05% or less by mass, the surface resistance at the time of the electrochemical surface-roughening treatment can be controlled. It is therefore possible to suppress concentration of electric current and form uniform pits having a size of 0.5 to 5 μm in the entire surface without forming any coarse pit.

In the present specification, various substrates made of above-mentioned aluminum or aluminum alloy are generically named “aluminum plates”. Examples of the alien elements which may be contained in the aluminum alloy include silicon, iron, manganese, copper, magnesium, chromium, zinc, bismuth, nickel, and titanium. The content of the alien elements in the alloy is 10% or less by mass. In order to prevent the formation of many deep concave portions in the electrochemical surface-roughening treatment using a nitric acid electrolyte, the content of copper is preferably 0.05% or less by mass.

The composition of the aluminum plate used in the invention is not specified. Materials which are conventionally known and described in Aluminum Handbook 4^{th} version (published by Japan Light Metal Association in 1990) can be appropriately used, examples of which include Al—Mn based aluminum plates such as aluminum plates of JIS A 1050, JIS A 1100, JIS A 1070, JIS A 3004 containing Mn, and Internationally Registered Alloy 3103A. The following can also be used: Al—Mg based alloys and Al—Mn—Mg based alloys (JIS A3005) wherein 0.1% or more by mass of magnesium is added to the above-mentioned aluminum alloys in order to improve the tensile strength; Al—Zr based alloys and Al—Si based alloys, which contain Zr or Si; and Al—Mg—Si based alloys.

Techniques about the JIS 1050 material are described in JP-A Nos. 59-153861, 61-51395, 62-146694, 60-215725, 60-215726, 60-215727, 60-216728, 61-272367, 58-11759, 58-42493, 58-221254, 62-148295, 4-254545, 4-165041, 3-234594 and 62-140894, and JP-B Nos. 3-68939 and 1-47545. Techniques thereon are disclosed in JP-B Nos. 1-35910 and 55-28874 also.

Techniques about the JIS 1070 material are described in JP-A Nos. 7-81264, 7-305133, 8-49034, 8-73974, 8-108659 and 8-92679.

Techniques about the Al-Mg based alloy are described in JP-B Nos. 62-5080, 63-60823, 3-61753, 3-11635, 4-73392, 7-100844, 4-73394, 5-76530 and 6-37116, and JP-A Nos. 60-203496, 60-203497, 61-274993, 62-23794, 63-47347, 63-47348, 63-47349, 64-1293, 63-135294, 63-87288, 62-149856, 62-181191 and 63-30294. Techniques thereon are described in JP-A Nos. 2-215599 and 61-20174 also.

Techniques about the Al—Mn based alloy are described in JP-A Nos. 60-230951, 1-306288 and 2-293189. Techniques thereon are described in JP-B Nos. 54-42284, 4-19290, 4-19291 and 4-19292, JP-A Nos. 61-35995, 64-51992 and 4-226394, and U.S. Pat. Nos. 5,009,722 and 5,028,276 also.

Techniques about the Al—Mn—Mg based alloy are described in JP-A Nos. 62-86143 and 3-222796. Techniques thereon are descried in JP-B No. 63-60824, JP-A Nos. 60-63346, 60-63347 and 1-293350, EP No. 223,737, U.S. Pat. No. 4,818,300, and GB Patent No. 1,222,777.

Techniques about the Al—Zr based alloy are described in JP-B No. 63-15978 and JP-A No. 61-51395. Techniques thereon are descried in JP-A Nos. 63-143234 and 63-143235 also.

The Al—Mg—Si based alloy is described in GB Patent No. 1,421,710.

In order to make aluminum alloy into a plate form, for example, the following methods can be adopted. First, molten aluminum alloy wherein the contents of alloy components are adjusted to given values is subjected to purifying treatment and then cast in a usual manner. The purifying treatment may be a flux treatment or degassing treatment with argon gas, chlorine gas or some other gas in order to remove unnecessary gases, such as hydrogen, in the molten metal; or a filtering treatment using a rigid medium filter (such as a ceramic tube filter or a ceramic foam filter), a filter using alumina fakes or alumina balls as filtering materials, a glass cloth filter, or some other filter; or a treatment wherein a degassing treatment is combined with a filtering treatment.

The purifying treatment is preferably conducted in order to prevent the generation of defects resulting from alien substances, such as nonmetal inclusions or oxides, in the molten metal, or defects resulting from gases dissolved into the molten metal. The filtering of molten metal is described in JP-A Nos. 6-57432, 3-162530, 5-140659, 4-231425, 4-276031, 5-311261, 6-136466 and so on. The degassing of molten metal is described in JP-A No. 5-51659, Japanese Utility Model Application Laid-Open (JP-U) No. 5-49148 and so on. The Applicant also suggests a technique on degassing of molten metal in JP-A No. 7-40017.

Next, the molten metal subjected to the above-mentioned purifying treatment is used and cast. The method for the casting is classified into methods using a solid casting mold, a typical example of which is DC casting, and methods using a driving cast mold, a typical example of which is continuous casting.

In the DC casting, the metal is solidified at a cooling rate ranging from 0.5 to 30° C./second. If the temperature is less than 1° C., coarse intermetallic compounds are produced in a large amount. When the DC casting is performed, ingots having a plate thickness of 300 to 800 mm can be produced. If necessary, the ingots are surface-cut in a usual way in such a manner that the surface layer thereof is usually cut by 1 to 30 mm, preferably 1 to 10 mm. Before and after the cutting, the ingots are subjected to soaking treatment if necessary. When the soaking treatment is conducted, heating treatment is conducted at 450 to 620° C. for 1 to 48 hours so that the intermetallic compound will not be made coarse. If the heating treatment is conducted for a shorter time than one hour, the effect of the soaking treatment may be insufficient.

Thereafter, the ingots are subjected to hot rolling and cold rolling, to prepare rolled plates made of aluminum. The starting temperature of the hot rolling is suitably from 350 to 500° C. Before and after the hot rolling or in the middle thereof, intermediate annealing treatment may be conducted. About the intermediate annealing treatment, a batch type annealing furnace is used to heat the aluminum at 280 to 600° C. for 2 to 20 hours, preferably at 350 to 500° C. for 2 to 10 hours, or a continuous system annealing furnace is used to heat the aluminum at 400 to 600° C. for 6 minutes or less, preferably at 450 to 550° C. for 2 minutes or less. The continuous system annealing treatment is used to heat the aluminum at a temperature-rising rate of 10 to 200° C./second, so that the crystalline structure thereof can be made fine.

Regarding the aluminum plate finished to have a given thickness, for example, a thickness of 0.1 to 0.5 mm through the above-mentioned steps, the flatness thereof may be improved by means of a reforming device such as a roller leveler or a tension leveler. The improvement in the flatness may be made after the aluminum plate is cut into a sheet form. In order to improve the productivity of the aluminum plate, it is preferable to make the improvement in the state that the plate is in a continuous coil form. In order to work the plate into a given width, the plate may be passed through a slitter line. In order to prevent the generation of injuries by friction between portions of the aluminum plate, a thin oily film may be laid on the surface of the aluminum plate. For the oily film, a volatile oil or nonvolatile oil is appropriately used.

As the continuous casting method, the following method is industrially performed: a method using a cooling roll, typical examples of which include the twin roll method (the Hunter method) and the 3C method; or a method using a cooling belt or cooling block, typical example of which include the twin belt method (the Hazelett method) and the method using an Alusuisse caster II model. When the continuous casting method is used, the ingots are solidified at a cooling rate of 100 to 1000° C./second. Since the cooling rate in the continuous casting method is generally faster than that in the DC casting method, the former method is characterized by making the solubility of alloy components into the matrix of aluminum high. Techniques about the continuous casting method are described in JP-A Nos. 3-79798, 5-201166, 5-156414, 6-262203, 6-122949, 6-210406 and 6-26308.

When a method using a cooling roll, for example, the Hunter method, is used in the continuous casting, an ingot plate having a plate thickness of 1 to 10 mm can be directly and continuously cast, thereby producing an advantage that the step of hot rolling can be omitted. When a method using a cooling belt, for example, the Hazelett method is used, an ingot plate having a plate thickness of 10 to 50 mm can be cast. In general, continuous cast rolled plates having a thickness of 1 to 10 mm can be obtained by casting an ingot and continuously rolling the cast ingot with a hot rolling roll arranged just after a device for the casting.

The resultant continuous cast rolled plate is finished to have a given thickness, for example, a thickness of 0.1 to 0.5 mm through cold rolling, intermediate annealing, flatness-improving, slit and other steps in the same manner as in the DC casting. In connection with conditions for the intermediate annealing and cold rolling when the continuous casting method is used, techniques are described in JP-A Nos. 6-220593, 6-210308, 7-54111, 8-92709 and so on.

It is desired that the thus-produced aluminum plate has various properties as described hereinafter.

Regarding the strength of the aluminum plate, the 0.2% yield strength thereof is preferably 140 MPa or more in order for the plate to obtain firmness necessary for any support for the planographic printing plate precursor. In order for the plate to obtain a measure of firmness when the plate is subjected to burning treatment, the 0.2% yield strength thereof is preferably 80 MPa or more, more preferably 100 MPa or more after the plate is subjected to heating treatment at 270° C. for 3 to 10 minutes. In the case that a particularly large firmness is desired for the aluminum plate, aluminum material to which Mg or Mn is added can be adopted. However, when the firmness is made large, the fitting ability of the plate to a printing drum of a printer deteriorates. Thus, the material for the plate and the amount of the trace components added thereto are appropriately selected in accordance with the purpose. In connection therewith, techniques are described in JP-A Nos. 7-126820 and 62-140894.

When the aluminum plate is subjected to the chemical surface-roughening treatment or electrochemical surface-roughening treatment, the crystalline structure of the plate may cause the generation of surface-quality poorness. Accordingly, it is preferable that the crystalline structure is not very coarse in the surface. About the crystalline structure in the surface of the aluminum plate, the width of textures therein is preferably 200 μm or less, more preferably 100 μm or less, and even more preferably 50 μm or less. The length of the textures is preferably 5000 μm or less, more preferably 1000 μm or less, and even more preferably 500 μm or less. In connection therewith, techniques are described in JP-A Nos. 6-218495, 7-39906 and 7-124609.

When the chemical surface-roughening treatment or electrochemical surface-roughening treatment is conducted, surface-quality poorness may be generated on the basis of an uneven distribution of the alloy components in the aluminum plate surface; therefore, it is preferable that the components are not very unevenly distributed. In connection therewith, techniques are described in JP-A Nos. 6-48058, 5-301478, and 7-132689.

Regarding intermetallic compounds in the aluminum plate, the size or density thereof may produce effect on the chemical surface-roughening treatment or electrochemical surface-roughening treatment. In connection therewith, techniques are described in JP-A Nos. 7-138687 and 4-254545.

In the invention, irregularities may be made in the above-mentioned aluminum plate by lamination rolling, transfer, or the like in a final rolling step.

The aluminum plate used in the invention is a sheet or plate material in a continuous belt form. That is, the aluminum plate may be an aluminum web or sheets each of which is cut into a size corresponding to a planographic printing plate precursor forwarded as a manufactured product.

Injures in the aluminum plate surface may become defects when the plate is worked into a support for the planographic printing plate precursor. It is therefore necessary to suppress the generation of the injuries as much as possible before the step of surface treatment for converting the aluminum plate to the planographic printing plate precursor support. For this purpose, the aluminum plate is preferably made into a package form which is stable and is not easily injured when carried.

In the case of the aluminum web, a package form of the aluminum may be obtained, for example, by laying a hard board and a felt on an iron palette, bringing corrugated board donut plates into contact with both ends of the aluminum product, packing the whole with polyethylene tubes, inserting a wood donut into the inner diameter portion of the web coil, applying a felt onto the outer circumference of the coil, tightening the coil with an iron belt, and then displaying information on the outer circumference thereof. As the packing material, polyethylene film may be used, and as the cushioning material, a needle felt or hard board may be used. Besides, various forms may be used if the forms make it possible to carry the aluminum web without giving any injury thereto.

The thickness of the aluminum plate used in the invention is from about 0.1 to 0.6 mm, preferably from 0.12 to 0.4 nm. This thickness may be appropriately changed in accordance with the size of the printer to be used, the size of the printing plate, user's desire, and others.

<Plate-Making>

In order to make up a planographic printing plate from the planographic printing plate precursor of the invention, at least processes for exposure to light and development are performed.

A preferable example of the light source which emits light to which the planographic printing plate precursor of the invention is exposed is an infrared laser. Thermal recording also can be applied to the precursor with an ultraviolet lamp or a thermal head.

In the invention, it is preferable to expose the precursor imagewise with a solid laser or a semiconductor laser emitting infrared rays having a wavelength of 750 to 1400 nm. The power of the laser is preferably 100 mW or more. In order to shorten the time for the exposure, it is preferable to use a multi-beam laser device. The time for the exposure per pixel is preferably 20 microseconds or less. The energy radiated onto the planographic printing plate precursor is preferably from 10 to 300 mJ/cm². If the exposure energy is too low, the negative type recording layer is not sufficiently cured. If the exposure energy is too high, the negative type recording layer undergoes laser ablation so that images therein may be damaged.

In the invention, the precursor can be exposed while the light beam from a light source is made into an overlap state. The word “overlap” means that the feed (or vertical) scanning pitch width of the beam is smaller than the diameter of the beam. When the beam diameter is represented by the half band width (FWHM) of the strength of the beam, the overlap can be quantitatively expressed by FWHM/the feed scanning pitch width (overlap coefficient). In the invention, the overlap coefficient is preferably 0.1 or more.

The manner of scanning the light source of the exposing device used in the invention is not particularly limited, and may be a cylinder outside surface scanning manner, a cylinder inside surface scanning manner, a flat surface scanning manner, or the like. The channel of the light source may be a single channel or a multi-channel. In the case of the cylinder outside surface scanning manner, the multi-channel is preferable.

The planographic printing plate precursor of the invention can be subjected to developing treatment without conducting any other treatment after the exposure. The developer used in this developing treatment is preferably an aqueous alkali solution having a pH of 14 or less, more preferably an aqueous alkali solution having a pH of 8 to 12 and containing an anionic surfactant. Examples of the alkali agent used in this solution include inorganic alkali agents such as trisodium phosphate, tripotassium phosphate, triammonium phosphate, disodium hydrogenphosphate, dipotassium hydrogenphosphate, diammonium hydrogenphosphate, sodium carbonate, potassium carbonate, ammonium carbonate, sodium hydrogencarbonate, potassium hydrogencarbonate, ammonium hydrogencarbonate, sodium borate, potassium borate, ammonium borate, sodium hydroxide, potassium hydroxide, ammonium hydroxide and lithium hydroxide; and organic alkali agents such as monomethylamine, dimethylamine, trimethylamine, monoethylamine, diethylamine, triethylamine, monoisopropylamine, diisopropylamine, triisopropylamine, n-butylamine, monoethanolamine, diethanolamine, triethanolamine, monoisopropanolamine, diisopropanolamine, ethyleneimine, ethylenediamine, and pyridine. These alkali agents may be used alone or in combination of two or more thereof.

In the developing treatment of the planographic printing plate precursor of the invention, an anionic surfactant is preferably added to a developer at a ratio of 1 to 20% by mass, more preferably at a ratio of 3 to 10% by mass. If the ratio of the surfactant is too small, the developing power of the solution deteriorates. If the ratio is too large, bad effects such that the strength properties (such as abrasion resistance) of the image deteriorate are produced. Examples of the anionic surfactant include a sodium salt of lauryl alcohol sulfate, an ammonium salt of lauryl alcohol sulfate, a sodium salt of octyl alcohol sulfate, a sodium salt of isopropylnaphthalenesulfonic acid, a sodium salt of isobutylnaphthalenesulfonic acid, a sodium salt of polyoxyethylene glycol mononaphthyl ether sulphate, a sodium salt of dodecylbenzenesulfonic acid, alkylarylsulfonates such as a sodium salt of m-nitrobenenesulfonic acid, esters of higher fatty alcohols having 8 to 22 carbon atoms, such as disodium alkylsulphate, phosphates of fatty alcohols, such as a sodium salt of cetyl alcohol phosphate, sulfonates of alkylamides, such as C₁₇H₃₃CON(CH₃)CH₂CH₂SO₃Na, and sulfonates of dibasic fatty esters, such as sodium dioctyl sulfosuccinate, and sodium dihexyl sulfosuccinate.

If necessary, an organic solvent miscible with water, such as benzyl alcohol, may be added to the developer. The organic solvent is preferably an organic solvent the solubility of which in water is about 10% or less by mass, more preferably 5% or less by mass. Examples thereof include 1-phenylethanol, 2-phenylethanol, 3-phenylpropanol, 1,4-phenylbutanol, 2,2-phenylbutanol, 1,2-phenoxyethanol, 2-benzyloxyethanol, o-methoxybenzyl alcohol, m-methoxybenzyl alcohol, p-methoxybenzyl alcohol, benzyl alcohol, cyclohexanol, 2-methylcyclohexanol, 4-methylcyclohexanol, and 3-methylcyclohexanol. The content of the organic solvent is preferably from 1 to 5% by mass of the total mass of the developer when used. The used amount of the organic solvent is closely related to that of the surfactant. It is preferable to make the amount of the anionic surfactant larger as the amount of the organic solvent is larger. This is because if the amount of the organic solvent is made large in the state that the amount of the anionic surfactant is small, the organic solvent is not dissolved so that a good developing power cannot be expected to be kept.

If necessary, additives such as an antifoamer and a water softener can be incorporated into the developer. Examples of the water softener include polyphosphates (such as Na₂P₂O₇, Na₅P₃O₃, Na₃P₃O₉, Na₂O₄P(NaO₃P)PO₃Na₂, and calgon (sodium polymetaphosphate)); aminopolycarboxylic acids (such as ethylenediaminetetraacetic acid, a potassium salt thereof, a sodium salt thereof, diethylenetriaminepentaacetic acid, a potassium salt thereof, a sodium salt thereof, triethylenetetraminehexaacetic acid, a potassium salt thereof, a sodium salt thereof, hydroxyethylethylenediaminetriacetic acid, a potassium salt thereof, a sodium salt thereof, nitrilotriacetic acid, a potassium salt thereof, a sodium salt thereof, 1,2-diaminocyclohexanetetracetic acid, a potassium salt thereof, a sodium salt thereof, 1,3-diamino-2-propanoltetraacetic acid, a potassium salt thereof, and a sodium salt thereof; other polycarboxylic acids (such as 2-phosphono-1,2,4-butanetricarboxylic acid, a potassium slat thereof, a sodium salt thereof, 2-phosphono-2,3,4-butanetricarboxylic acid, a potassium salt thereof, and a sodium salt thereof); and organic phosphonic acids (such as 1-phosphono-1,2,2-ethanetricarboxylic acid, a potassium salt thereof, a sodium salt thereof, 1-hydroxyethane-1,1-diphosphonic acid, a potassium salt thereof, a sodium thereof, aminotri(methylenephosphonic acid), a potassium salt thereof, and a sodium salt thereof). The optimal amount of such a water softener varies in accordance with the hardness of the used hard water and the amount thereof, and is generally contained in the developer when used at a ratio of 0.01 to 5% by mass, preferably at a ratio of 0.01 to 0.5% by mass.

In the case of using an automatic developing machine to develop the planographic printing plate precursors, the developer gets fatigued in accordance with the amount of the processed precursors; therefore, a replenisher or a new developer may be used to restore the developing power of the original solution. In this case, it is preferable to attain the replenishment by a method described in U.S. Pat. No. 4,882,246. It is also preferable to use developers described in JP-A Nos. 50-26601 and 58-54341 and JP-B Nos. 56-39464, 56-42860 and 57-7427.

The planographic printing plate precursor developed as described above may be subjected to post-treatment with washing water, rinse solution containing surfactant etc., or desensitizing solution containing gum arabic, a starch derivative and others, as described in JP-A Nos. 54-8002, 55-115045, and 59-58431. In the post-treatment of the planographic printing plate precursor of the invention, various combinations of these treatments may be conducted.

In the plate-making from the planographic printing plate precursor of the invention, it is effective to apply heating or exposure of the entire surface thereof to light to the image after the development.

In the heating after the development, very strict conditions may be used. However, the heating is usually performed in the temperature range of 200 to 500° C. in order to give a sufficient image-strengthening effect and suppress the damage of the support and the image portion by the heat.

The planographic printing plate obtained by the above-mentioned treatments is fitted into an offset printer, thereby giving a great number of printed sheets.

The planographic printing plate obtained from the planographic printing plate precursor of the invention may be cleaned with a plate cleaner in order to remove stains on the plate in the middle of the step of continuous printing. The plate cleaner used at this time may be a known plate cleaner for PS plates. Specific examples thereof include cleaners CL-1, CL-2, CP, CN-4, CN, CG-1, PC-1, SR and IC (each of which is manufactured by Fuji Photo Film Co., Ltd.)

### EXAMPLES

The present invention is described by way of the following examples. However, the invention is not limited to these examples.

There are first described synthesis examples of typical compounds of the polymer (B) having on its side chain a phenyl group substituted with a vinyl group and the monomer (C) having two or more phenyl groups each substituted with a vinyl group, which are used in the invention.

### Synthesis Example 1

### Synthesis Example of a Specific Polymer (P-1) as One of the Specific Polymers (B)

Into 600 mL of methanol was suspended 150 g of bismuthiol (2,5-dimercapto-1,3-4-thiadiazole). While the system was cooled, 101 g of triethylamine was gradually added to the suspension to yield a homogeneous solution. While the system was kept at room temperature, p-chloromethylstyrene (CMS-14, manufactured by Seimi Chemical Co., Ltd.) was dropwise added to the solution over 10 minutes. The solution was continuously stirred for 3 hours. A reaction product was gradually precipitated. After the stirring, the precipitation was transferred to an ice bath and the internal temperature thereof was lowered to 10° C. Thereafter, the product was separated by suction filtration and washed with methanol. The product was dried all day and night in a vacuum drying machine to yield a compound (monomer) (yield: 75%) represented by the following:

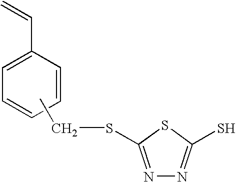

Into a 1-liter four-neck flask equipped with a stirrer, a nitrogen introducing tube, a thermometer, and a reflex condenser was charged 40 g of the above-mentioned monomer. Thereto were added 70 g of methacrylic acid, 200 mL of ethanol, and 50 mL of distilled water. While the solution was stirred, 110 g of triethylamine was added thereto over a water bath. The system was heated in nitrogen atmosphere so that the internal temperature thereof would be 70° C. At this temperature, 1 g of azoisobutyronitrile (AIBN) was added to the solution so as to start polymerization. The solution was heated and stirred for 6 hours. Thereafter, the polymerization system was cooled to room temperature. A portion was separated out therefrom. Thereto was added dilute hydrochloric acid to adjust the pH to about 3. This was poured into water to yield a polymer having a structure represented by the following:

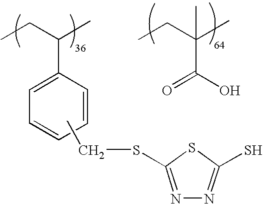

To the polymer solution remaining after the separation of the above-mentioned portion were added 100 g of 1,4-dioxane and 23 g of p-chloromethylstyrene, and then the solution was continuously stirred at room temperature for 15 hours. Thereafter, thereto was added 80 to 90 g of concentrated hydrochloric acid (35 to 37% solution thereof in water). After it was observed that the pH of the system became 4 or less, the whole was transferred into 3 liters of distilled water. The precipitated polymer was separated by filtration, repeatedly washed with distilled water, and dried all day and night in a vacuum drying machine. In this way, a target specific polymer (P-1) was obtained (yield: 90%). Molecular weight measurement by gel permeation chromatography demonstrated that the polymer was a polymer having a weight-average molecular weight of 90000 (in terms of polystyrene), and analysis by proton NMR supported the structure of the specific polymer (P-1).

### Synthesis Example 2

### Synthesis Example of a Specific Monomer (C-5) as One of the Specific Monomers (C)

Into 1.5 L of methanol was suspended 89 g of thiocyanuric acid. While the system was cooled, a 30% solution of potassium hydroxide in water, wherein 84 g of potassium hydroxide was dissolved, was gradually added to the suspension to yield a homogeneous solution. While the system was kept at room temperature, 230 g of p-chloromethylstyrene was dropwise added to the solution in such a manner that the internal temperature would not exceed 40° C. In a short time after the addition, a product was precipitated. The solution was continuously stirred. After the stirring for 3 hours, the product was separated by suction filtration and washed with methanol. The product was dried all day and night in a vacuum drying machine to yield a specific monomer (C-5) (yield: 90%).

### Example 1

[Formation of a Support]

<Aluminum Plate>

The following alloy was used to prepare a molten metal: an aluminum alloy containing 0.08% by mass of Si, 0.30% by mass of Fe, 0.001% by mass of Cu, 0.001% by mass of Mn, 0.001% by mass of Mg, 0.001% by mass of Zn and 0.015% by mass of Ti, and Al and inevitable impurities as the balance. After the metal melting treatment followed by filtration, a DC casting method was used to produce an ingot having a length of 500 mm and a width of 1200 mm. The surface thereof was cut off by an average thickness of 10 mm by means of a surface cutter. Thereafter, the ingot was subjected to soaking treatment at 550° C. for about 5 hours. When the temperature of the ingot was lowered to 400° C., a hot rolling machine was used to produce a rolled plate having a thickness of 2.7 mm. Furthermore, a continuous annealing machine was used to subject the plate to heat treatment at 500° C. Thereafter, the plate was cold-rolled to be finished into a thickness of 0.30 mm. In this way, an aluminum plate of JIS 1050 material was obtained. This aluminum plate was made into a width of 1030 mm, and then subjected to the following surface treatment.

<Surface Treatment>

Surface treatment was conducted by carrying out the following (a) to (j) treatments continuously. After each of the treatments and water washing, the solution or water used therein was cleared away by means of a nip roller.

(a) Mechanical Surface-Roughening Treatment

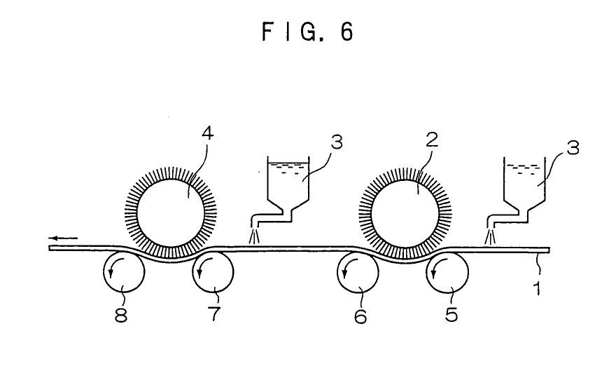

A machine shown in FIG. 6 was used to supply a suspension (specific gravity: 1.12) of an abrasive (pumice, average grain diameter: 30 μm) in water, as an abrading slurry, onto a surface of the aluminum plate, and simultaneously the surface was subjected to mechanical surface-roughening treatment with rotating roller-form nylon brushes. In FIG. 6, reference number 1 represents the aluminum plate; 2 and 4, the roller-form brushes; 3, the abrading slurry; and 5, 6, 7 and 8, supporting rollers. The average grain diameter of the abrasive grains was 30 μm. The material of the nylon brushes was 6,10-nylon, the bristle length thereof was 50 mm, and the bristle diameter thereof was 0.48 mm. The nylon brushes were each obtained by making holes in a stainless steel cylinder having a diameter of 300 mm and then planting bristles densely (the bristle density of the brushes: 450 per cm²). The number of the used rotating brushes was three. The distance between the two supporting rollers (diameter: 200 mm) under each of the brushes was 300 mm. Each of the brush rollers was pushed against the aluminum plate until the load of a driving motor for rotating the brush got 7 kW larger than the load before the brush roller was pushed against the aluminum plate. The rotating direction of the brush was the same as the moving direction of the aluminum plate. The rotation speedof the brush was 200 rpm.

(b) Alkali Etching Treatment

An aqueous solution having a caustic soda concentration of 26% by mass, an aluminum ion concentration of 6.5% by mass and a temperature of 70° C. was sprayed to etch the aluminum plate, thereby dissolving the aluminum plate by 10 g/m². Thereafter, the aluminum plate was washed with sprayed water.

(c) Desmutting Treatment

The aluminum plate was subjected to desmutting treatment with a 30° C. aqueous solution having a nitric acid concentration of 1% by mass (and containing 0.5% by mass of aluminum ions), which was sprayed, and then washed with sprayed water. The aqueous nitric acid solution used in the desmutting treatment was waste liquid from the step of conducting electrochemical surface-roughening treatment using alternating current in an aqueous nitric acid solution.

(d) Electrochemical Surface-Roughening Treatment

Alternating current having a frequency of 60 Hz was used to conduct electrochemical surface-roughening treatment continuously. The electrolyte used at this time was a 9 g/L solution of nitric acid in water (containing 5 g/L of aluminum ions and 0.007% by mass of ammonium ions), and the temperature thereof was 50° C. The waveform of the alternating current was a waveform shown in FIG. 3. This trapezoidal wave alternating current was used. The time TP until the current value was raised from zero to a peak was 0.8 msec, and the duty ratio of the current was 1:1. A carbon electrode was used as a counter electrode to conduct the electrochemical surface-roughening treatment. Ferrite was used as an auxiliary anode. As an electrolyte bath, a bath illustrated in FIG. 4 was used.

The density of the current was 30 A/dm² when the current was at the peak. The total of electricity quantities when the aluminum plate functioned as an anode was 185 C/dm². 5% of the current sent from a power source was caused to flow into the auxiliary anode.

Thereafter, the aluminum plate was washed with sprayed water.

(e) Alkali Etching Treatment

An aqueous solution having a caustic soda of 26% by mass and an aluminum ion concentration of 6.5% by mass was used to etch the aluminum plate at 32° C. so as to dissolve the aluminum plate by 0.25 g/m², thereby removing smut components made mainly of aluminum hydroxide and generated when the alternating current was used to conduct the electrochemical surface-roughening treatment in the previous step, and further dissolving edges of formed pits so as to be made smooth. Thereafter, the aluminum plate was washed with sprayed water.

(i) Desmutting Treatment

The aluminum plate was subjected to desmutting treatment with a 30° C. aqueous solution having a nitric acid concentration of 300 g/L (and containing 4.5% by mass of aluminum ions), which was sprayed, and then washed with sprayed water. The aqueous nitric acid solution used in the desmutting treatment was waste liquid from the step of conducting the electrochemical surface-roughening treatment using the alternating current in the aqueous nitric acid solution.

(g) Electrochemical Surface-Roughening Treatment

Alternating current having a frequency of 60 Hz was used to conduct electrochemical surface-roughening treatment continuously. The electrolyte used at this time was a 5 g/L solution of hydrochloric acid in water (containing 5 g/L of aluminum ions), and the temperature thereof was 35° C. The waveform of the alternating current was a waveform shown in FIG. 3. This trapezoidal wave alternating current was used. The time TP until the current value was raised from zero to a peak was 0.8 msec, and the duty ratio of the current was 1:1. A carbon electrode was used as a counter electrode to conduct the electrochemical surface-roughening treatment. Ferrite was used as an auxiliary anode. As an electrolyte bath, a bath illustrated in FIG. 4 was used.

The density of the current was 25 A/dm² when the current was at the peak. The total of electricity quantities when the aluminum plate functioned as an anode was 50 C/dm².

Thereafter, the aluminum plate was washed sprayed water.

(h) Alkali Etching Treatment

An aqueous solution having a caustic soda of 5% by mass and an aluminum ion concentration of 6.5% by mass was used to etch the aluminum plate at 30° C. so as to dissolve the aluminum by 0.10 g/m², thereby removing smut components made mainly of aluminum hydroxide and generated when the alternating current was used to conduct the electrochemical surface-roughening treatment in the previous step, and further dissolving edges of formed pits so as to be made smooth. Thereafter, the aluminum plate was washed with sprayed water.

(i) Desmutting Treatment

The aluminum plate was subjected to desmutting treatment with a 60° C. aqueous solution having a sulfuric acid concentration of 300 g/L (and containing 0.5% by mass of aluminum ions), which was sprayed, and then washed with sprayed water.

(j) Anodic Oxidation Treatment

An anodic oxidation device having the structure illustrated in FIG. 5 was used to conduct anodic oxidation treatment to yield a planographic printing plate precursor support of Example 1. The electrolytes supplied into first and second electrolyzing sections were each sulfuric acid. The electrolytes were each an electrolyte having a sulfuric acid concentration of 170 g/L (and containing 0.5% by mass of aluminum ions), and the temperature thereof was 38° C. Thereafter, the support was washed with sprayed water to yield a planographic printing plate precursor support A of Example 1. The final amount of the oxidation film was 2.7 g/m².

### Example 2

A planographic printing plate precursor support B of Example 2 was yielded in the same way as in Example 1 except that in the mechanical surface-roughening treatment in the item (a) the average grain diameter of the abrasive grains was set to 20 μm.

### Example 3

A planographic printing plate precursor support C of Example 3 was yielded in the same way as in Example 1 except that none of the treatments in the items (a), (g), (h) and (i) were conducted.

### Example 4

A planographic printing plate precursor support D of Example 4 was yielded in the same way as in Example 1 except that in the mechanical surface-roughening treatment in the item (a) the bristle density of the brushes was set to 700 per cm².

### Comparative Example 1

A planographic printing plate precursor support E of Comparative Example 1 was yielded in the same way as in Example 1 except that none of the treatments in the items (a), (g), (h) and (i) were conducted and in the electrochemical surface-roughening treatment in the item (d) the current density was set to 20 A/dm² when the current was at a peak.

### Comparative Example 2

A planographic printing plate precursor support F of Comparative Example 2 was yielded in the same way as in Example 1 except that none of the treatments in the items (g), (h) and (i) were conducted and the mechanical surface-roughening treatment in the item (a) the average grain diameter of the abrasive grains was set to 25 μm.

<Measurement of the Surface Shape of the Planographic Printing Plate Precursor Support>

Regarding concave portions or irregularities in the surface of each of the planographic printing plate precursor supports obtained as above, values in the following items (1) to (6) were measured.

The results are shown in Table 1. In Table 1, the symbol “−” shows that concave portions or irregularities having a corresponding wavelength were not present.

(1) Central Line Average Roughness Ra

A profilometer (Surfcom 575, manufactured by Tokyo Seimitsu Co.) was used to carry out two-dimensional roughness measurement, thereby measuring the average roughness of the surface prescribed in ISO 4287 five times. The average thereof was defined as the central line average roughness Ra.

Conditions for the two-dimensional roughness measurement were as follows: cutoff value: 0.8 mm, inclination correction: FLAT-ML, measurement length: 3 mm, lengthwise magnification: 10000 powers, scanning rate: 0.3 mm/sec, and tip diameter of the probe: 2 μm.

(2) Average Wavelength of the Large Wave Structure

The profilometer (Surfcom 575, manufactured by Tokyo Seimitsu Co.) was used to carry out two-dimensional roughness measurement, thereby measuring the average mountain interval Sₘ prescribed in ISO 4287 five times. The average thereof was defined as the average wavelength. Conditions for the two-dimensional roughness measurement were as follows:
cutoff value: 0.8 mm, inclination correction: FLAT-ML, measurement
length: 3 mm, lengthwise magnification: 10000 powers, scanning rate:
0.3 mm/sec, and tip diameter of the probe: 2 μm.
   (3) Average Aperture of the Medium Wave Structure

An SEM was used to take a picture of the surface of the support from just above with 2000 magnifications. From the obtained SEM photograph, 50 pits of the medium wave structure (medium wave pits), the circumferences of which were stretched in a ring form, were extracted. The diameters thereof were read out. The read values were regarded as the apertures of the medium wave pits. From the apertures, the average aperture thereof was calculated.

(4) Average Aperture of the Small Wave Structure

A high-resolution SEM was used to take a picture of the surface of the support from just above with 50000 magnifications. From the obtained SEM photograph, 50 pits of the small wave structure (small wave pits) were extracted. The diameters thereof were read out. The read values were regarded as the apertures of the small wave pits. From the apertures, the average aperture thereof was calculated.

(5) Counting of the Number of Concave Portions Having a Depth of 3 μm or More

A three-dimension non-contact surface shape measuring device of a light interferential type (Micromap 520, manufactured by Ryoka Systems Inc.) was used to scan a 400 μm² area in the surface at a pitch of 0.01 μm in a non-contact manner so as to obtain three-dimensional data. From the three-dimensional data, the number of concave portions having a depth of 3 μm or more was counted. The number thereof per mm² was calculated. In Table 1, the number thereof per mm² is shown as “The number of concave portions”. Besides the above-mentioned surface shape measuring device, for example, a super-depth shape measuring microscope VK 5800 of a laser type, manufactured by Keyence Corp., can also be used as a three-dimension non-contact surface shape measuring device.

[Negative Type Recording Layer]

Next, the following recording layer coating solution was prepared, and the coating solution was applied onto the surface of each of the above-mentioned supports A to F so as to have a thickness of 1.4 μm after the solution was dried. The support was dried in a drying machine at 70° C. for 5 minutes to form a recording layer. In this way, a planographic printing plate precursor [CTP] was produced.

<Recording Layer Coating Solution>

| | |
|---|---|
| the specific polymer (P-1) [component (B)] | 10 parts by weight |
| a photoradical generator (BC-6) [component (A)] | 2 parts by weight |
| a photoradical generator (T-4) [component (A)] | 1 part by weight |
| the specific monomer (C-5) [component (C)] | 3.5 parts by weight |
| a sensitizing dye (S-34) [component (D)] | 0.5 part by weight |
| a chloride salt of ethyl violet | 0.3 part by weight |
| dioxane | 70 parts by weight |
| cyclohexane | 20 parts by weight |

(Sensitivity Evaluation)

The planographic printing plate precursor [CTP] produced as described above was exposed to light from a Trendsetter 3244 VX manufactured by Creo Co., in which a water-cooling type 40W infrared semiconductor laser was mounted, such that the rotation speed of its outside surface drum was 150 rpm and the power of the laser was changed by 0.15 at a time as log E within the range of 0 to 8 W, to obtain a 50% screen tint image having a resolution of 1751 pi. The exposure was performed at 25° C. and 50 % RH. After the exposure, the plate precursor was developed with a developer in which 6% by mass of sodium metasilicate was dissolved, at 30° C. for 10 seconds. The minimum exposure energy at which the screen tint image in the planographic printing plate obtained by the development became 50% was obtained as the sensitivity of the photosensitive material. The results are shown in Table 1.

(Evaluation of Stability Over Time)

The planographic printing plate precursor [CTP] was kept at 25° C. and 70 % RH for 2 hours, and then wrapped with an aluminum kraft. The planographic printing plate precursor was allowed to stand at 45° C. for 3 days. The resultant sample was developed under the same conditions as for the sensitivity evaluation. The density of the non-image portions was measured with a Macbeth reflection densitometer RD-918. The difference Δfog between the resultant density and the density of the non-image portions measured at the time of the sensitivity evaluation was obtained, and the difference was used as an index of the stability of the plate over time. The smaller the Δfog is, the better stability over time is. A value of 0.02 or less is at such a level that no practical problems are caused.

(Printing Durability, and Stain Resistance Evaluation)

The planographic printing plate precursor [CTP] was exposed to light from the Trendsetter 3244 VX manufactured by Creo Co., in which the water-cooling type 40 W infrared semiconductor laser was mounted, in such that the rotation speed of the outside surface drum was 150 rpm, the power of the laser was 6 W and the plate surface energy was 100 mJ/cm², to obtain an 80% screen tint image having a resolution of 1751 pi. After the exposure, the plate was developed in the same way as in the developing step in the sensitivity evaluation. The resultant planographic printing plate and a printer Lithron (transliteration) manufactured by Komori Corporation were used to print images on sheets. The number of obtained image-printed sheets was used as an index of the printing durability. The printing stain resistance was evaluated on the basis of 5 levels by observing ink staining on the non-image portions with the naked eye. The larger the number of the evaluation level is, the better the stain resistance is. An evaluation level of 4 or more is a practical level, and the evaluation level 3 is the lower limit of permissible levels. The results are shown in Table 1.

TABLE 1

| | | | | | | | Evaluation of the | | | |
|---|---|---|---|---|---|---|---|---|---|---|
| | Support | | | | | | planographic printing plate precursors | | | |
| | | The number | Central line | | | | | | Printing | |
| | | of concave | average | Large wave | Medium wave | Small wave | | Stability | durability | |
| | | portions | roughness | Wavelength | Average | | Sensitivity | over time | (the number | Stain |
| | | (per mm²) | (μm) | (μm) | aperture (μm) | | (mJ/cm²) | Δfog | of sheets) | resistance |
| Example 1 | Support A | 50 | 0.52 | 50 | 1.4 | 0.14 | 105 | 0 | 100000 | 5 |
| Example 2 | Support B | 22 | 0.46 | 43 | 1.4 | 0.15 | 105 | 0 | 100000 | 5 |
| Example 3 | Support C | 10 | 0.35 | — | 2 | — | 100 | 0.01 | 120000 | 3 |
| Example 4 | Support D | 45 | 0.57 | 50 | 1.4 | 0.14 | 105 | 0 | 100000 | 5 |
| Comparative | Support E | 10 | 0.2 | — | 2 | — | 100 | 0.04 | 120000 | 2 |
| Example 1 | | | | | | | | | | |
| Comparative | Support F | 30 | 0.75 | 50 | 1.4 | — | 150 | 0 | 40000 | 4 |
| Example 2 | | | | | | | | | | |

As is evident from Table 1, any one of the planographic printing plate precursors of Examples 1 to 4 was excellent in all of sensitivity, stability over time, printing durability, and stain resistance. The comparison of Examples 1, 2 and 4 with Example 3 demonstrates that aluminum supports having a preferable surface grain structure produce the advantageous effects of the invention remarkably. On the other hand, in Comparative Example 1, wherein the central line average roughness Ra of its support was too small, the stability thereof over time and the stain resistance thereof were poor and at a level such that practical problems would be caused. In Comparative Example 2, wherein the central line average roughness Ra of its support was too large, the sensitivity thereof and the printing durability thereof were poor and at a level such that practical problems would be caused.

According to the invention, it is possible to provide a planographic printing plate precursor which has a high sensitivity to infrared rays, exhibits no staining in non-image portions obtained at the time of printing, and is excellent in printing durability.

1. A planographic printing plate precursor comprising:
an aluminum support which has been subjected to surface-roughening treatment and anodic oxidation treatment and has a central line average roughness Ra of 0.25 to 0.7 μm; and
a negative type recording layer which is provided on the aluminum support and comprises a compound (A) which can generate a radical by application of light or heat, a polymer (B) having on its side chain a phenyl group substituted with a vinyl group, a monomer (C) having two or more phenyl groups each substituted with a vinyl group, and an infrared absorbing agent (D).

2. A planographic printing plate precursor according to claim 1, wherein the polymer (B) is a polymer having on its side chain a group represented by the following formula (1): 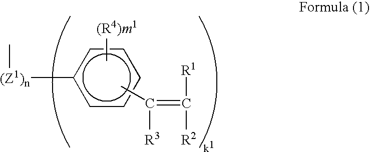
wherein Z¹ represents a linking group; R¹, R² and R³ each independently represent a hydrogen or halogen atom, or a carboxyl, sulfo, nitro, cyano, amide, amino, alkyl, aryl, alkoxy or aryloxy group, which may be further substituted with an alkyl, amino, aryl, alkenyl, carboxyl, sulfo or hydroxyl group; R⁴ represents a group or atom which can be substituted; n is 0 or 1; m¹ is an integer from 0 to 4; and k¹ is an integer from 1 to 4.

3. A planographic printing plate precursor according to claim 2, wherein in the formula (1), R¹ and R² represent hydrogen atoms; R³ represents a hydrogen atom or a lower alkyl group having 4 or less carbon atoms; Z¹ represents a linking group containing a heterocyclic structure; and k¹ is 1 or 2.

4. A planographic printing plate precursor according to claim 2, wherein the polymer (B) has a weight-average molecular weight of 1,000 to 1,000,000.

5. A planographic printing plate precursor according to claim 2, wherein the polymer (B) has a weight-average molecular weight of 10,000 to 300,000.

6. A planographic printing plate precursor according to claim 2, wherein the polymer (B) is contained in an amount of 10 to 90% by mass relative to a total solid content in the negative type recording layer.

7. A planographic printing plate precursor according to claim 1, wherein the compound (A) is a radical generator selected from the group consisting of organic boron salts, trihaloalkyl-substituted compounds, hexaarylbisimidazoles, titanocene compounds, ketooxime compounds, thio compounds, and organic peroxide compounds.

8. A planographic printing plate precursor according to claim 1, wherein the compound (A) is contained in an amount of 1 to 100% by mass relative to an amount of the polymer (B).

9. A planographic printing plate precursor according to claim 1, wherein the compound (A) is contained in an amount of 1 to 40% by mass relative to an amount of the polymer (B).

10. A planographic printing plate precursor according to claim 1, wherein the monomer (C) is a compound represented by the following formula (3): 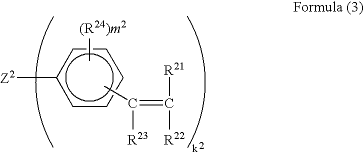
wherein Z² represents a linking group; R²¹, R²² and R²³ each independently represent a hydrogen or halogen atom, or a carboxyl, sulfo, nitro, cyano, amide, amino, alkyl, aryl, alkoxy or aryloxy group, which may be further substituted with an alkyl, amino, aryl, alkenyl, carboxyl, sulfo or hydroxyl group; R²⁴ represents a group or atom which can be substituted; m² is an integer from 0 to 4; and k² is an integer greater than or equal to 2.

11. A planographic printing plate precursor according to claim 10, wherein the linking group represented by Z² is one, or a combination of at least two, selected from the group consisting of an oxygen atom, a sulfur atom, an alkylene group, an alkenylene group, an arylene group, —N(R⁵)——C(O)—O—, —C(R⁶)═N—, —C(O)—, a sulfonyl group, a group containing a heterocyclic structure and a group containing a benzene ring structure; and R⁵ and R⁶ each independently represent a hydrogen atom, an alkyl group or an aryl group.

12. A planographic printing plate precursor according to claim 1, wherein the monomer (C) is contained in an amount of 0.01 to 10 parts by mass per 1 part by mass of the polymer (B).

13. A planographic printing plate precursor according to claim 1, wherein the monomer (C) is contained in an amount of 0.05 to 1 parts by mass per 1 part by mass of the polymer (B).

14. A planographic printing plate precursor according to claim 1, wherein the infrared absorbing agent (D) is a dye or pigment which has an absorption maximum at a wavelengths of 760 to 1200 nm.

15. A planographic printing plate precursor according to claim 14, wherein the infrared absorbing agent (D) is the pigment, and the pigment is contained in an amount of 0.01 to 50% by mass relative to a total solid content in the negative type recording layer.

16. A planographic printing plate precursor according to claim 14, wherein the infrared absorbing agent (D) is the pigment, and the pigment is contained in an amount of 0.1 to 10% by mass relative to a total solid content in the negative type recording layer.

17. A planographic printing plate precursor according to claim 1, further comprising a thermopolymerization inhibitor.

18. A planographic printing plate precursor according to claim 17, wherein the thermopolymerization inhibitor is selected from the group consisting of hydroquinone, p-methoxyphenol, di-t-butyl-p-cresol, pyrogallol, t-butylcatecol, benzoquinone, 4,4′-thiobis(3-methyl-6-t-butylphenol), 2,2′-methylenebis(4-methyl-6-t-butylphenol), and a cerium (III) salt of N-nitrosophenylhydroxylamine.

19. A planographic printing plate precursor according to claim 17, wherein the thermopolymerization inhibitor is contained in an amount of 0.01 to 5% by mass relative to a total solid content in the negative type recording layer.

20. A planographic printing plate precursor according to claim 1, wherein a grain structure of the surface of the aluminum support is a structure wherein a large wave structure having an average wavelength of 5 to 100 μm, a medium wave structure having an average aperture of 0.5 to 5 μm, and a small wave structure having an average aperture of 0.01 to 0.2 μm are superimposed, and the number of concave portions which are present in the surface and have a depth of 3 μm or more is from 10 to 60 per mm².
